(19) United States
(12) Patent Application Publication
(10) Pub. No.: US 2010/0076811 A1
(43) Pub. Date: Mar. 25, 2010

(54) DYNAMICALLY PROVIDING DIGITAL CONTENT FROM RELEVANT SOURCES AND IDENTIFYING CONTENT DISPLAY OPPORTUNITIES, SUCH AS DYNAMICALLY PROVIDING ADVERTISEMENTS FROM RELATED PUBLICATIONS AND INDENTIFYING TARGET ADVERTISERS

(76) Inventors: Jesse Keller, New York, NY (US); Todd Krizelman, New York, NY (US)

Correspondence Address: PERKINS COIE LLP;Jessica M. Meyers, P.O. Box 1247, Seattle, WA, 98111-1247, US

(21) Appl. No.: 12/236,470

(22) Filed: Sep. 23, 2008

(51) Int. Cl. G06Q 30/00; G06Q 50/00

(52) U.S. Cl. 705/10; 705/14.42

(57) ABSTRACT

A method and system for facilitating management of content display opportunities, such as management of advertising accounts of a magazine publisher, includes recommendations, talking points, and a user interface for displaying content, such as digital images of magazine advertisements. Recommended content display opportunities, such as recommended advertisers for a publication associated with a user, are presented to the user based on information related to the user and information related to multiple advertisers. In addition, recommended discussion points for a communication with a content provider, such as an advertiser, may be provided. The method and system also include a user interface for presenting content from multiple content sources, such as digital images of magazine advertisements from multiple magazines, including magazines that are not associated with the user. Digital images of magazine advertisements may be displayed in response to selection by the user of a magazine, an issue, and an advertiser.

### BACKGROUND

As more and more content continues to be published, content publishers increasingly face competition from other content publishers. For example, more and more magazines are being published each year. Magazine publishers compete with each other for advertising dollars, audiences, and prestige. To determine which advertisers are advertising in a competitor's magazine and, in particular, which advertisement pages are being run in the competitor's magazine, a magazine publisher can obtain a physical copy of its competitor's magazine and browse the magazine.

Each magazine publisher may have advertising accounts with multiple advertisers. Many advertisers run advertisements in a magazine on a routine basis. For example, an advertiser may run advertisements in each issue of a magazine. In addition, each magazine publisher may have advertisers, or leads, with which the publisher is interested in establishing an account. These advertisers may advertise in a competitor's magazine, run advertisements in high value positions, or otherwise be desirable candidates for advertising in a publication.

### BRIEF DESCRIPTION OF THE DRAWINGS

FIG. 1 is a block diagram of a basic and suitable computer that may employ aspects of the described technology.

FIG. 2 is a block diagram illustrating a simple, yet suitable system in which aspects of the described technology may operate in a networked computer environment.

FIG. 3 is a suitable display diagram of a user interface for setting up a personalized profile.

FIGS. 4A and 4B are suitable display diagrams of a user interface for selecting a list of competitors.

FIG. 5 is a suitable display diagram of a user interface for selecting a list of advertising accounts.

FIG. 6 is a suitable display diagram of a user interface for specifying preferences for receiving system alerts.

FIG. 7 is a display diagram of an example email alert that may be distributed to a user.

FIG. 8 is a suitable display diagram of a user interface for selecting a list of product categories.

FIG. 9 is a suitable display diagram of a user interface for specifying account settings.

FIG. 10 is a display diagram of an example recommendation that may be presented to a user.

FIG. 11 is a display diagram of an example user interface that incorporates a recommendation.

FIG. 12 is a display diagram of an example account review page for an advertiser.

FIG. 13 is a suitable display diagram of a user interface for presenting talking points.

FIG. 14 is a display diagram of additional examples of talking points.

FIGS. 15A-D are display diagrams of an example cheat-sheet that may be generated for an advertiser.

FIGS. 16A-D are display diagrams of a suitable user interface for browsing digital images of magazine advertisements in a single-issue mode.

FIGS. 17A-C are display diagrams of a suitable user interface for browsing digital images of magazine advertisements in an all-issues mode.

FIG. 18 is a display diagram of a suitable user interface for browsing digital images of magazine advertisements.

FIG. 19 is a display diagram of a suitable user interface for browsing digital images of magazine advertisements that displays the newest issues for which digital images of advertisements are available.

FIG. 20 is a display diagram of a suitable user interface feature for adding an advertiser to a favorites list.

FIG. 21 is a display diagram of an example demographic report for an advertiser.

FIG. 22 is a display diagram of an example household income detail report for an advertiser.

FIG. 23 is a suitable display diagram of an advertisement strip.

FIG. 24 is a suitable display diagram of an advertisement viewer.

FIG. 25 is a display diagram of suitable user interface for presenting a user's favorites list.

FIG. 26 is a suitable display diagram used to display multiple brands associated with an advertiser.

FIG. 27 is a display diagram of an example recommendation score for an advertiser.

FIG. 28 is a display diagram of an example recommendation score explanation.

FIG. 29 is a suitable display diagram for providing indications of available reports.

FIG. 30 is a display diagram of an example report.

FIG. 31 is a flow diagram of a suitable process for generating a recommendation.

FIG. 32 is a flow diagram of a suitable process for generating talking points.

FIG. 33 is a flow diagram of a suitable process for browsing digital images of magazine advertisements.

Note: the headings provided herein are for convenience and do not necessarily affect the scope or interpretation of the described technology.

### DETAILED DESCRIPTION

Described below is a method and system for dynamically providing digital content from relevant sources and identifying content display opportunities, such as dynamically providing advertisements from related publications and identifying target advertisers.

Various implementations of the technology will now be described. The following description provides specific details for a thorough understanding and enabling description of these implementations. One skilled in the art will understand, however, that the described technology may be practiced without many of these details. Additionally, some well-known structures or functions may not be shown or described in detail, so as to avoid unnecessarily obscuring the relevant description of the various implementations.

The terminology used in the description presented below is intended to be interpreted in its broadest reasonable manner, even though it is being used in conjunction with a detailed description of certain specific implementations of the described technology. Certain terms may even be emphasized below; however, any terminology intended to be interpreted in any restricted manner will be overtly and specifically defined as such in this Detailed Description section.

### 1. System Configuration

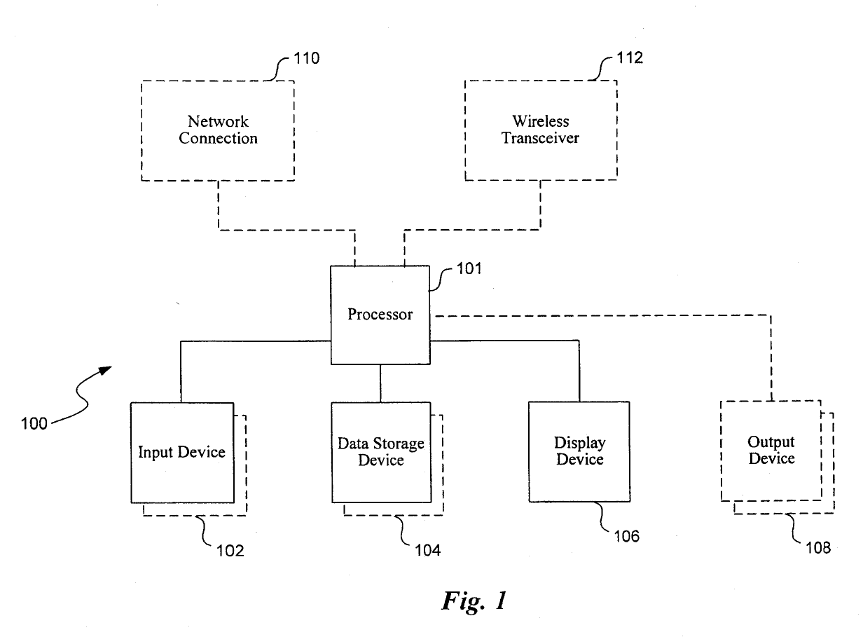

FIG. 1 and the following discussion provide a brief, general description of a suitable computing environment in which aspects of the described technology can be implemented. Although not required, aspects and implementations of the described technology will be described in the general context of computer-executable instructions, such as routines executed by a general-purpose computer, e.g., a server or personal computer. Those skilled in the relevant art will appreciate that the described technology can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers, and the like. The described technology can be embodied in a special purpose computer or data processor that is specifically programmed, configured or constructed to perform one or more of the computer-executable instructions explained in detail below. Indeed, the term “computer,” as used generally herein, refers to any of the above devices, as well as any data processor or any device capable of communicating with a network, including consumer electronic goods such as game devices, cameras, or other electronic devices having a processor and other components, e.g., network communication circuitry.

The described technology can also be practiced in distributed computing environments, where tasks or modules are performed by remote processing devices, which are linked through a communications network, such as a Local Area Network (“LAN”), Wide Area Network (“WAN”), or the Internet. In a distributed computing environment, program modules or sub-routines may be located in both local and remote memory storage devices. Aspects of the technology described below may be stored or distributed on computer-readable media, including magnetic and optically readable and removable computer discs, stored as firmware in chips (e.g., EEPROM chips), as well as distributed electronically over the Internet or over other networks (including wireless networks). Those skilled in the relevant art will recognize that portions of the described technology may reside on a server computer, while corresponding portions reside on a client computer. Data structures and transmission of data particular to aspects of the described technology are also encompassed within the scope of the described technology.

Referring to FIG. 1, one embodiment of the described technology employs a computer 100, such as a personal computer or workstation, having one or more processors 101 coupled to one or more user input devices 102 and data storage devices 104. The computer is also coupled to at least one output device such as a display device 106 and one or more optional additional output devices 108 (e.g., printer, plotter, speakers, tactile or olfactory output devices, etc.). The computer may be coupled to external computers, such as via an optional network connection 110, a wireless transceiver 112, or both.

The input devices 102 may include a keyboard and/or a pointing device such as a mouse. Other input devices are possible such as a microphone, joystick, pen, game pad, scanner, digital camera, video camera, and the like. The data storage devices 104 may include any type of computer-readable media that can store data accessible by the computer 100, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to or node on a network such as a LAN, WAN, or the Internet (not shown in FIG. 1).

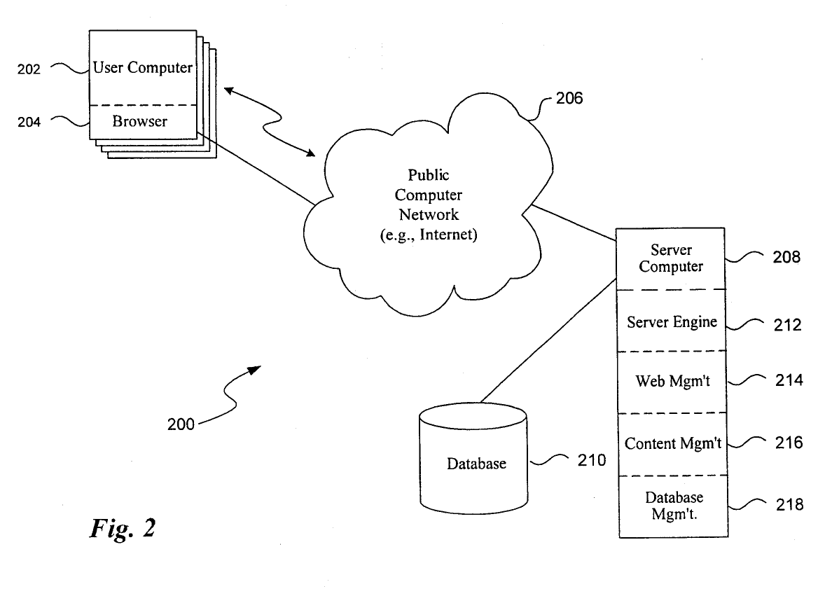

Aspects of the described technology may be practiced in a variety of other computing environments. For example, referring to FIG. 2, a distributed computing environment with a web interface includes one or more user computers 202 in a system 200. Each of the user computers 202 includes a browser program module 204 that permits the computer to access and exchange data with the Internet 206, including web sites within the World Wide Web portion of the Internet. The user computers may be substantially similar to the computer described above with respect to FIG. 1. User computers may include other program modules such as an operating system, one or more application programs (e.g., word processing or spread sheet applications), and the like. The computers may be general-purpose devices that can be programmed to run various types of applications, or they may be single-purpose devices optimized or limited to a particular function or class of functions. More importantly, while shown with web browsers, any application program for providing a graphical user interface to users may be employed, as described in detail below; the use of a web browser and web interface are only used as a familiar example here.

At least one server computer 208, coupled to the Internet or World Wide Web (“Web”) 206, performs much or all of the functions for receiving, routing and storing of electronic messages, such as web pages, audio signals, and electronic images. While the Internet is shown, a private network, such as an intranet may indeed be preferred in some applications. The network may have a client-server architecture, in which a computer is dedicated to serving other client computers, or it may have other architectures such as a peer-to-peer, in which one or more computers serve simultaneously as servers and clients. A database 210 or databases, coupled to the server computer(s), stores much of the web pages and content exchanged between the user computers. The server computer(s), including the database(s), may employ security measures to inhibit malicious attacks on the system, and to preserve integrity of the messages and data stored therein (e.g., firewall systems, secure socket layers (SSL), password protection schemes, encryption, and the like).

The server computer 208 may include a server engine 212, a web page management component 214, a content management component 216 and a database management component 218. The server engine performs basic processing and operating system level tasks. The web page management component handles creation and display or routing of web pages. Users may access the server computer by means of a URL associated therewith. The content management component handles most of the functions in the implementations described herein. The database management component includes storage and retrieval tasks with respect to the database, queries to the database, and storage of data.

The system maintains a variety of information on publications and content providers. In some implementations, the publications are magazines and the content providers are advertisers. While many examples of the technology will be described in the context of magazines and advertisers herein, the technology is not limited to this context. One skilled in the art will appreciate that the technology can be applied in the context of other types of publications and other content providers.

In some implementations, digital images of magazine advertisements are added to the system. For example, digital images of magazine advertisements may be stored in one or more databases 210 of a system server 208, as described in reference to FIG. 2. Digital images of magazine advertisements may be added to the database(s) manually or automatically. For example, digital images of magazine advertisements may be added manually by a system administrator. A system administrator may cut advertisements out of magazines and scan the magazines in to the server 208, or may otherwise manually input magazine advertisements in order to generate digital images of the magazine advertisements. Digital images of magazine advertisements may also be added to the system automatically. For example, web sites associated with one or more advertisers or magazines may periodically be searched by the system to obtain digital images of magazine advertisements. One skilled in the art will appreciate that digital images of magazine advertisements may be obtained in these and other ways.

The system maintains a variety of metadata on each magazine advertisement for which a digital image is stored. For example, the metadata may be stored in one or more databases 210 of the system server 208. In some implementations, the system maintains metadata for each magazine advertisement that includes one or more advertisers associated with the advertisement, a magazine in which the advertisement appeared, the issue of the magazine in which the advertisement appeared, and other information. In some implementations, this metadata is entered into the system manually by a system administrator.

In some cases, the system and/or a system administrator may associate a magazine advertisement with multiple advertisers. Advertisements often mention multiple brands. For example, an advertisement for Nike may read “available at FootLocker.” As another example, an ad for a food product may include the logo of its parent company. In such implementations, the system may maintain several pieces of advertiser- and/or brand-related metadata on each advertisement, including “primary brand,” “product example,” “retail location,” and “also-mentioned.”

A primary brand identifies a primary product or company advertised by an advertisement. The system associates each advertisement with at least one primary brand; in some implementations, advertisements may be associated with more than one primary brand.

A product example identifies a particular model or type of product. Some advertisements promote an entire product line. For example, an advertisement may promote the entire line of Samsung mobile phones, while featuring one or more example products, e.g., SP-101, SP-103, and SP-1000. In such an example, the system would identify Samsung as the primary brand, and the specific model numbers as product examples.

A retail location identifies a location at which a primary brand may be purchased. A retail location may be a physical location (e.g., a storefront) or a virtual location (e.g., a web site of a retailer). For example, advertisements may list one or more locations at which a user may buy a primary brand. Such locations are often identified under a heading such as “Available at.”

Also-mentioned advertisers include advertisers that are mentioned in an advertisement, but which are not classified as a primary brand, a product example, or a retail location. For example, advertisements may include logos for other brands, such as a parent company or one or more sponsors of an event.

In some implementations, the system maintains metadata regarding the number of pages that comprise each advertisement and/or the total number of pages advertised in a magazine by an advertiser. Magazine advertisements may be measured in a variety of sizes, including 1 page, ⅔ page, ½ page, ⅓ page, ¼ page, and ⅛ page. The number of pages comprising an advertisement may be used as an approximation of an advertiser's advertising spending, as it can be difficult to determine an advertiser's actual advertising spending. In some cases, an advertisement does not lend itself to a traditional page count. For example, an advertisement may comprise a bind-in, a poster, or another nontraditional advertisement. Accordingly, in some implementations, bind-ins are counted at 50% of standard page values, while posters are counted as 2 pages. One skilled in the art will appreciate that the number of pages of other types of advertisements may also be approximated.

In some implementations, the system classifies advertisers and/or advertisements based on one or more product categories. For example, the system may store metadata related to product categories typically displayed in an advertiser's advertisements. The system may maintain hundreds or thousands of product categories, including Bridal, Cigarettes, Cigarettes & Tobacco, Financial & Real Estate, Telecommunication, Travel & Leisure, Book Clubs, Food & Food Products, Toiletries & Cosmetics, Home Furnishings & Supplies, Vineyard/Winery, Public Service, Retail, Athletics, and other product categories. One skilled in the art will appreciate that a variety of other product categories may be associated with advertisers and/or advertisements.

### 2. Personalized Profile

Each user's interactions with the system are unique. In some implementations, the factors that impact a user's interactions with the system include the user's magazine, advertising accounts, and competitors (herein also referred to as the user's “competitive set”).

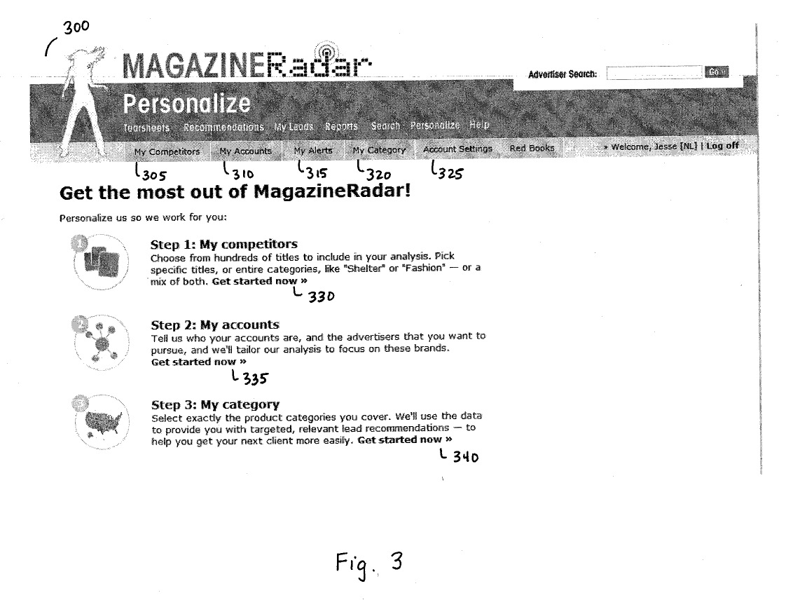

To begin accessing the functionalities of the system, in some implementations, a user sets up a personalized profile via a user interface, such as via a web site associated with the system. FIG. 3 is a display diagram of a user interface 300 that the system provides to allow a user to set up a personalized profile in some implementations. The user interface 300 allows the user to select competitors, advertisers, and product categories for which analysis and recommendations are to be generated. In addition, the user interface allows the user to specify account settings, set preferences for receiving alerts or notifications, and access other functionalities of the system.

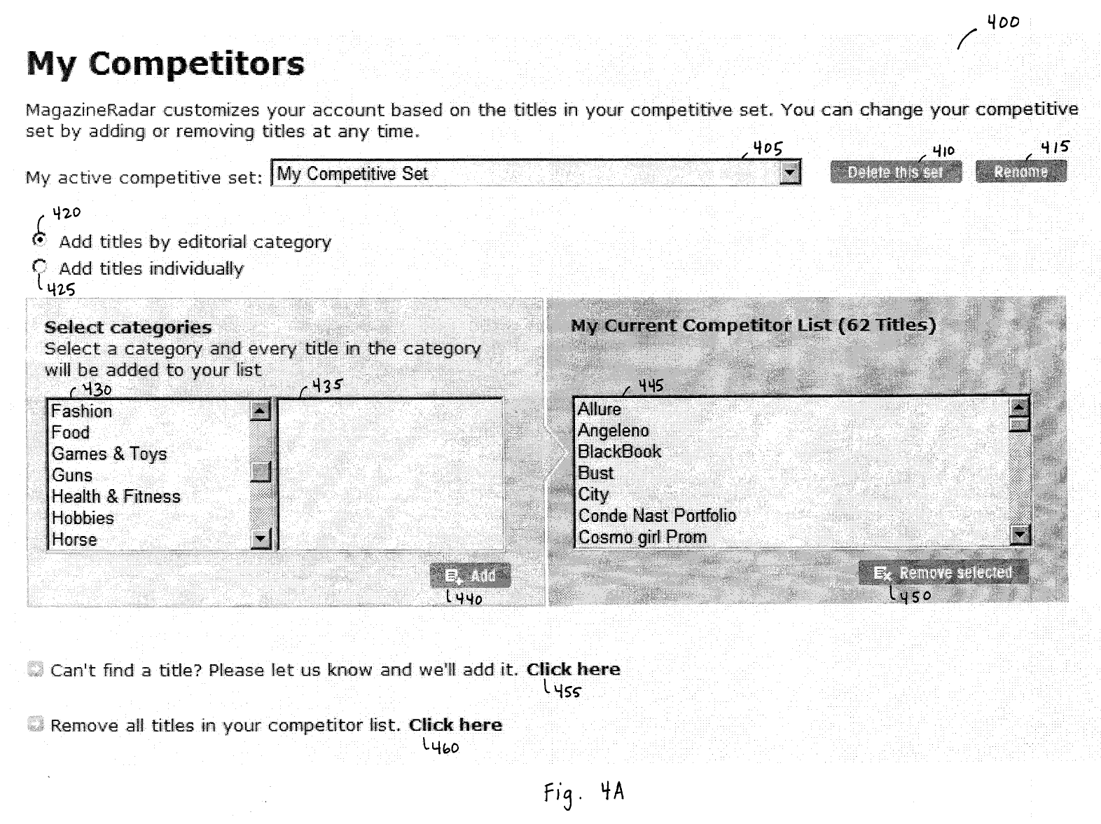

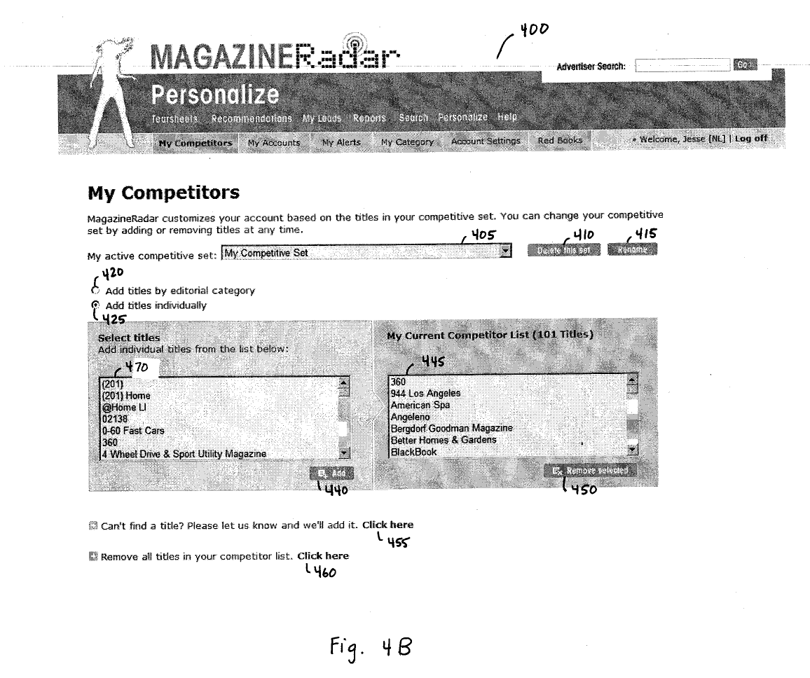

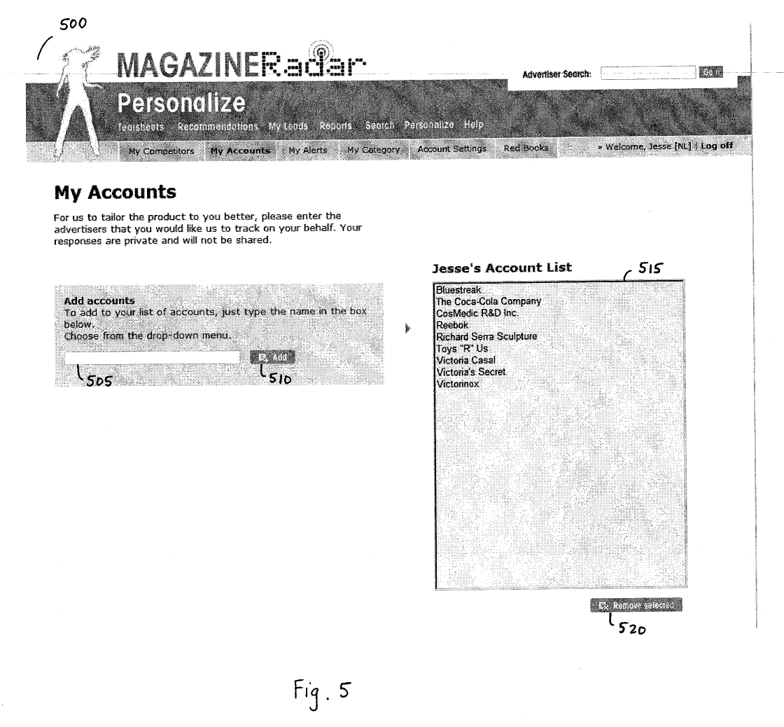

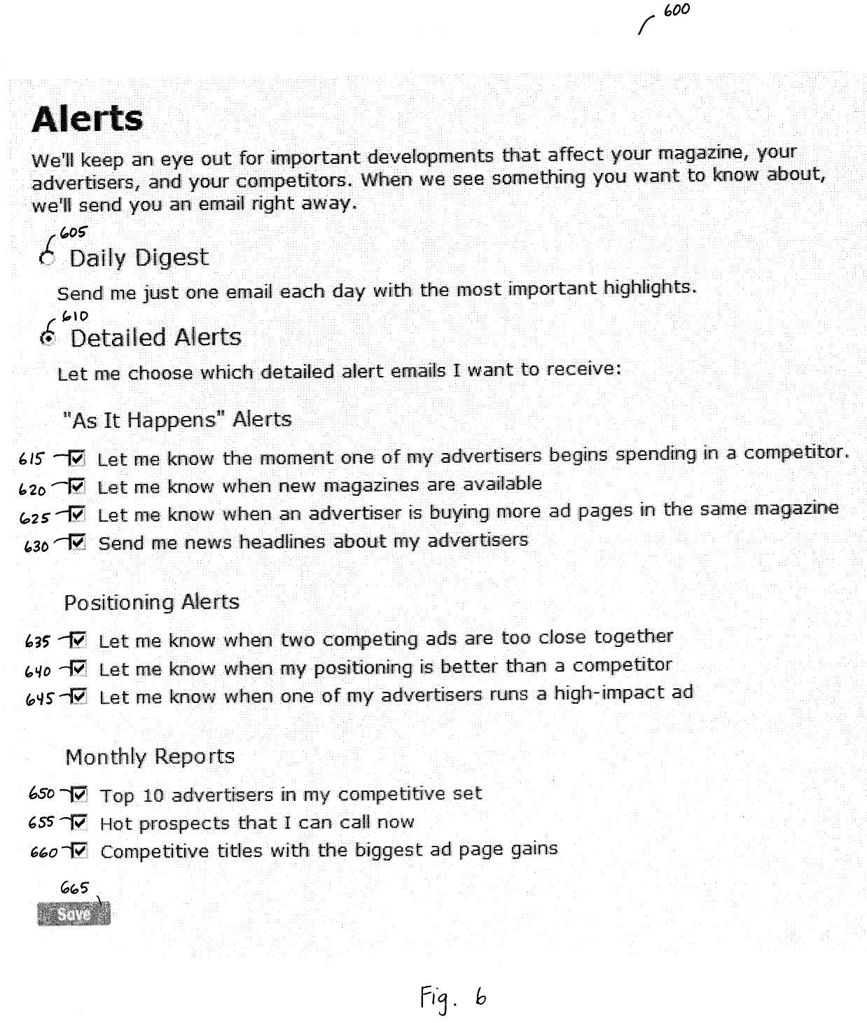

For example, the user may select one or more competitors for which analysis and recommendations are to be generated, such as by selecting a “My Competitors” link 305 or a “Get started now >>” link 330 under the description of “Step 1: My competitors.” In some implementations, selecting link 305 or link 330 of FIG. 3 will direct the user to a user interface 400 that the system provides to allow the user to select one or more competitors, as depicted by FIGS. 4A and 4B.

FIGS. 4A and 4B are display diagrams of a user interface 400 that the system provides to allow the user to select one or more competitors for which analysis and recommendations are to be generated in some implementations. The user may define one or more “competitive sets” via the user interface 400. A competitive set is a group of one or more magazines that is included in the analysis, calculations, recommendations, reports, and other functions performed by the system. A competitive set may be manually or automatically defined. For example, a competitive set may be manually selected by the user via user interface 400. The user first selects an active competitive set to manage by selecting a competitive set, such as “My Competitive Set,” from a drop down box 405. The user may delete or rename a selected competitive set by selecting button 410 or 415, respectively.

Once a user has selected an active competitive set via the drop down box 405, the user may select whether to add magazines to the active competitive set as a group based on the magazines' editorial category, or individually based on the magazines' titles, by selecting radio button 420 or 425, respectively. FIG. 4A depicts the user interface 400 in which the user has selected radio button 420, allowing the user to add magazines to the competitive set as a group, based on the editorial category of the magazines.

The user may select one or more editorial categories from a list box 430 to add the magazines of the selected editorial category to the competitive set. For example, the list box 430 depicts editorial categories including Fashion, Food, Games & Toys, Guns, Health & Fitness, Hobbies, and Horse. Other editorial categories may include Education, Family, Boating & Sailing, Entertainment & Media, Shelter/Home, and other categories. When an editorial category is selected by the user, the magazines included in the editorial category are displayed in list box 435. The user may select one, multiple, or all of the magazines displayed in list box 435 to add to the competitive set, such as by selecting the desired magazines (e.g., by clicking on a magazine title or pressing “Ctrl” and clicking on multiple magazine titles) and then selecting an “Add” button 440. In some implementations, editorial categories are organized and presented to a user hierarchically. For example, each editorial category may be split into multiple subcategories. For example, a “Health & Fitness” category may be split into several subcategories, including “Running” and “Bodybuilding.” Each subcategory may further be split into sub-subcategories, and so on.

A user may alternatively or additionally select to add magazines to the competitive set individually based on the magazines' titles, by selecting radio button 425. FIG. 4B depicts the user interface 400 in which the user has selected radio button 425. The user may select one or more individual magazine titles from a list box 470 to add to the competitive set. For example, the list box 470 depicts individual magazine titles in alphabetical order. One skilled in the art will appreciate that individual magazine titles may be presented to the user in another manner.

Referring again to both FIGS. 4A and 4B, list box 445 displays the magazine titles currently in the competitive set. When magazines are selected by the user, the titles of the selected magazines are added to the competitive set and displayed in the list box 445. The user may remove one, multiple, or all of the magazines from the active competitive set by selecting the desired magazines and then selecting a “Remove selected” button 450. In addition, if the user wants to remove all of the magazine titles from the active competitive set, the user may select a “Click here” link 460. If the user is unable to find a magazine title that the user would like to add to the active competitive set, the user may select on a “Click here” link 455. By selecting the link 455, the user is presented with an opportunity to provide feedback to the system and/or a system administrator. For example, in response to the selection of the link 455, the system may provide the user with a feedback form in which the user can add the title of a magazine that the user cannot find, contact information for the user in case a system administrator has questions, a comments section, and/or other information.

In addition to being defined manually, a competitive set may be defined automatically by the system. For example, in some implementations, a user starts with a competitive set defined as follows: all magazines in the same editorial category as the user, in addition to any magazine that carries ads from at least 20% of the user's magazine's advertisers. In some implementations, calculations of which magazines to include in a competitive set may be made in real time, such that the magazines in the competitive set are up to date with the latest system information. The user may modify an automatically defined competitive set, such as by selecting magazines to add to a competitive set, and removing other magazines from the competitive set. One skilled in the art will appreciate that a competitive set may be automatically and/or manually defined in other ways.

Returning to FIG. 3, the user may also select one or more advertisers to be tracked on the user's behalf, such as by selecting a “My Accounts” link 310 or a “Get started now >>” link 335 under the description of Step 2: My accounts.” In some implementations, selecting link 310 or 335 of FIG. 3 will direct the user to a user interface 500 that the system provides to allow the user to select one or more advertising accounts, as depicted by FIG. 5.

FIG. 5 depicts a display diagram of a user interface 500 that the system provides to allow the user to select one or more advertisers to be tracked by the system on a user's behalf in some implementations. The user may select one or more advertisers by typing a name of an advertiser into a text box 505. Once the user begins typing the name of an advertiser into the text box 505, the user interface 500 may display a drop down menu (not shown in FIG. 5) from which the user may select a desired advertiser. For example, if the user types “A” into the text box 505, the user interface 500 may display a drop down menu that includes all advertisers that begin with the letter A. As the user continues typing in the text box 505, the list of advertisers included in the drop down menu may dynamically change to match the characters the user has typed into the text box 505. The user may finish typing an advertiser's name or select an advertiser from the drop down box. Once the user has selected an advertiser, the user may add the advertiser to a list of advertisers that the system is tracking for the user, such as by selecting an “Add” button 510.

List box 515 contains a list of advertisers that the system is to track on the user's behalf. When a user selects an advertiser in text box 505 or its associated drop down menu and selects the “Add” button 510, as described above, the selected advertiser is added to the list box 515. The user may also remove advertisers from the list box 515, such as by selecting one, multiple, or all of the advertisers in the list box 515 and selecting a “Remove selected” button 520.

Returning to FIG. 3, the user may also specify preferences for receiving alerts, or notifications, from the system, such as by selecting a “My Alerts” link 315. In some implementations, selecting the link 315 will direct the user to a user interface 600 that the system provides to allow a user to specify alert preferences, as depicted by FIG. 6.

FIG. 6 depicts a display diagram of a user interface 600 that the system provides to allow a user to specify preferences for receiving alerts, or notifications, from the system. Alerts notify users of events, conditions, and/or other information that may be relevant to the user. The user may select to receive a daily email with important highlights, by selecting radio button 605, or the user may select to receive certain detailed alerts, by selecting radio button 610 and one or more check boxes 615-660.

Detailed alerts may include “As It Happens” Alerts 615-630, Positioning Alerts 635-645, Monthly Reports 650-660, and other alerts not depicted by FIG. 6. “As It Happens” Alerts may include an alert 615 that notifies the user the moment one of the user's advertisers begins spending advertising dollars in a competitor's publication; an alert 620 that notifies the user when new magazines are available; an alert 625 that notifies the user when an advertiser is buying more advertising pages in the same magazine; an alert 630 that sends the user news headlines about the user's advertisers; and other alerts. Positioning Alerts may include an alert 635 that notifies the user when two competing advertisements are too close together in the user's magazine or the magazine of a competitor; an alert 640 that notifies the user when it offers an advertiser better positioning in its magazine than does a competitor; an alert 645 that notifies the user when one of the user's advertiser's runs a high-impact advertisement; and other alerts. Monthly Reports may include a report 650 of the top ten advertisers in the user's competitive set; a report 655 of hot advertising prospects to whom the advertiser can immediately place a call; a report 660 of the user's competitors who have had the biggest gains in advertising pages; and other reports. The user can save his or her selections by selecting a “Save” button 665.

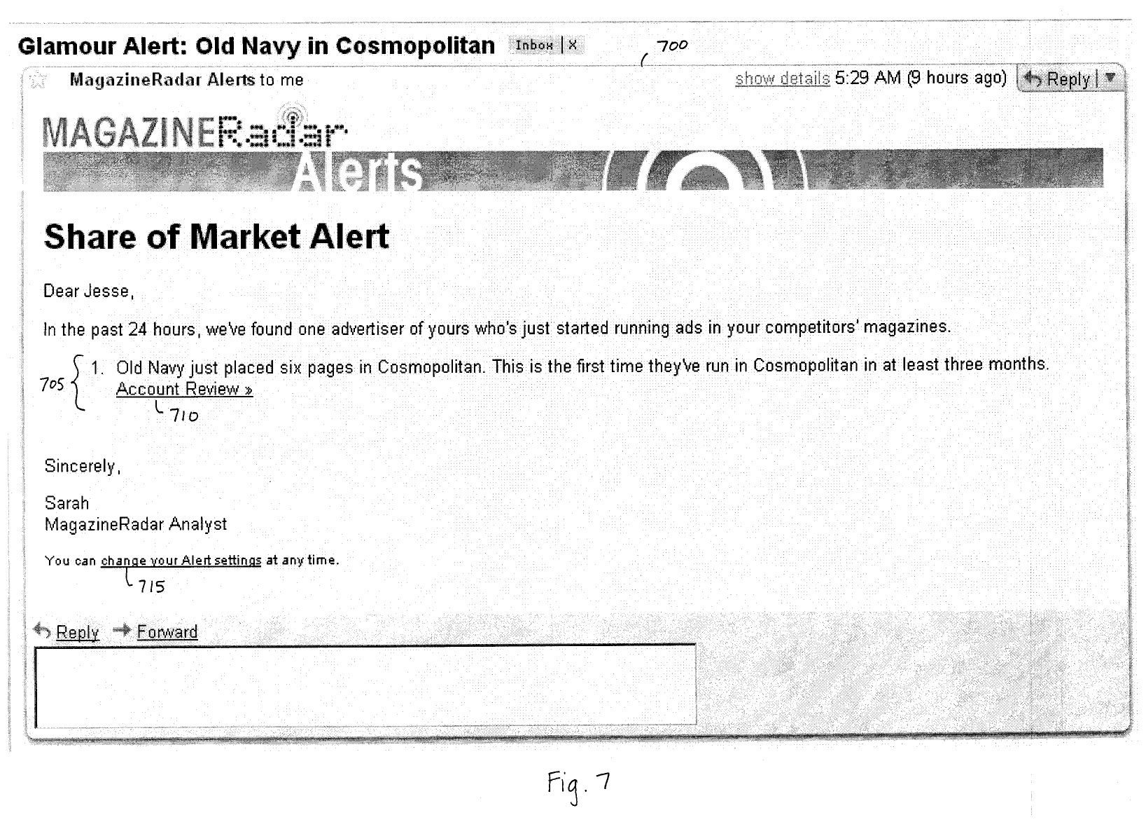

Alerts may be distributed to the user via email, via a user interface within the system web site, and/or in other ways. FIG. 7 is a display diagram of an example email alert 700 that the system may distribute to a user. The email alert 700 includes an indication 705 of one of the user's advertisers that has begun running advertisements in a competitor's magazine. For example, the indication 705 explains, “Old Navy just placed six pages in Cosmopolitan. This is the first time they've run in Cosmopolitan in at least three months.” The email alert 700 contains a link 710 to a full account review of the advertiser, Old Navy. In addition, the email alert 700 contains a link 715 that allows the user to change his or her preferences for receiving alerts.

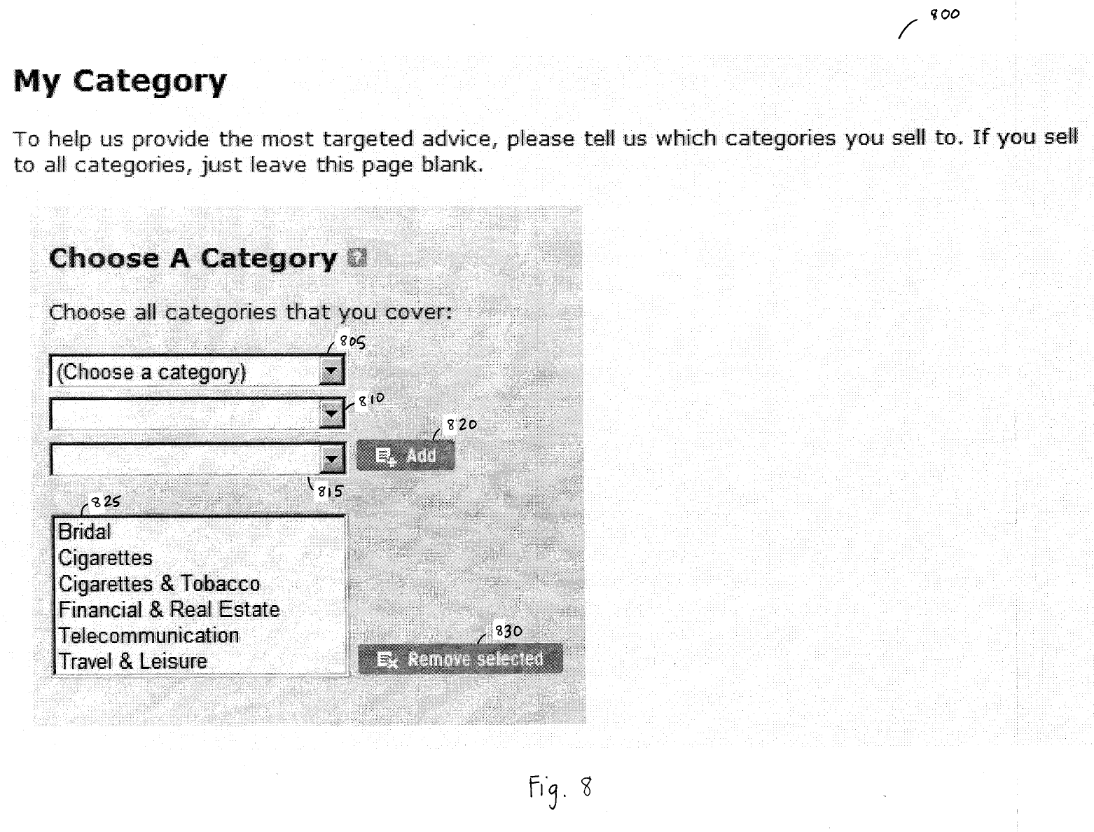

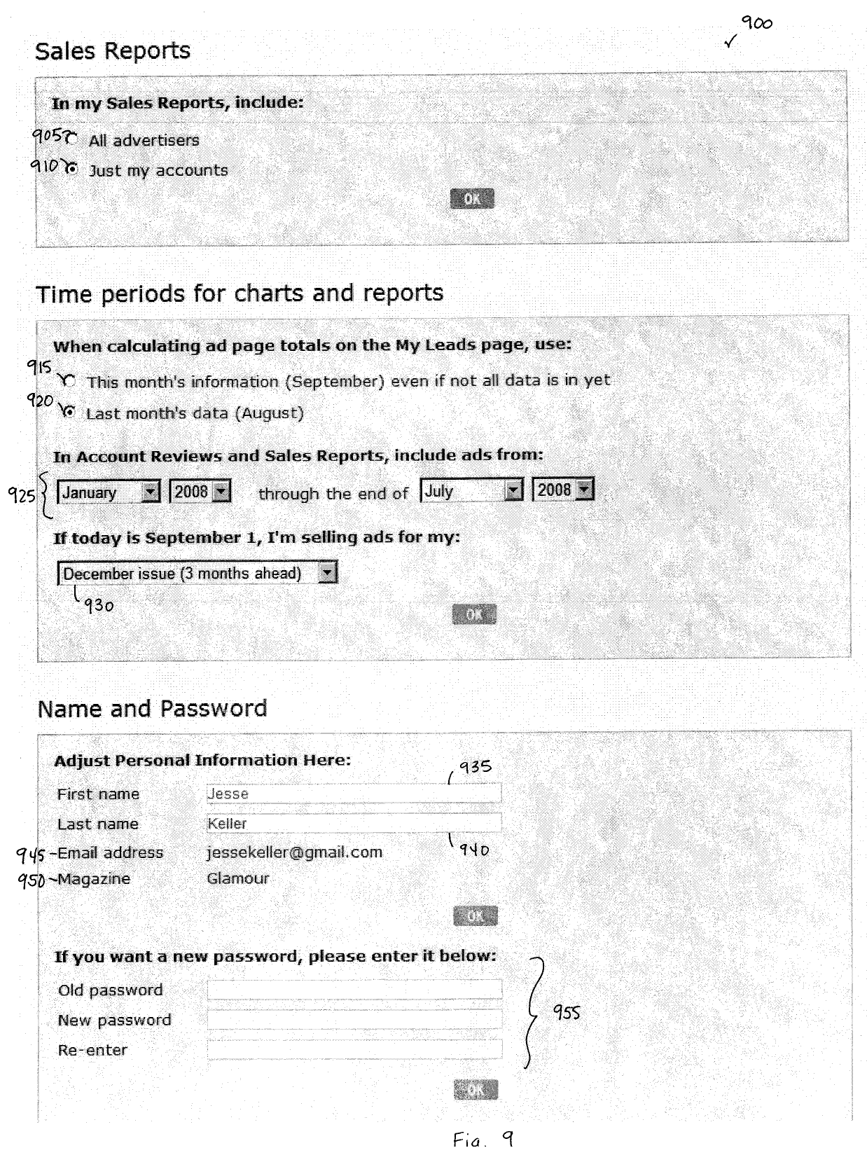

Returning to FIG. 3, the user may also select one or more product categories for which analysis and recommendations are to be generated, such as by selecting a “My Category” link 320 or a “Get started now >>” link 340 under the description of “Step 3: My category.” In some implementations, selecting link 320 or 340 of FIG. 3 will direct the user to a user interface 700 that the system displays to allow the user to select one or more product categories, as depicted by FIG. 8.

FIG. 8 is a display diagram of a user interface 800 that the system provides to allow the user to select one or more product categories for which analysis and recommendations are to be generated in some implementations. Each product category specifies types of advertisers' products that are advertised in the user's magazine. As described above, the system may maintain hundreds or thousands of product categories. A user may select one or more product categories from drop down menus 805-815 and add these product categories to a list of product categories for the user, such as by selecting an “Add” link 820. However, in some implementations, the user is not required to select any product categories for which analysis and recommendations are to be generated. For example, if the user does not select any product categories, the system may generate analysis and recommendations for the user in all product categories.

A list box 825 indicates the product categories in the user's product category list. For example, the list box 825 includes the product categories Bridal, Cigarettes, Cigarettes & Tobacco, Financial & Real Estate, Telecommunication, and Travel & Leisure. Other product categories may include Book Clubs, Food & Food Products, Toiletries & Cosmetics, Home Furnishings & Supplies, Vineyard/Winery, Public Service, Retail, Athletics, and other product categories. One skilled in the art will appreciate that many other product categories may be selected by a user. In some implementations, product categories are organized hierarchically, similar to the editorial categories described above. A user may remove one, multiple, or all of the product categories from the list box 825 of the product categories from the list box 825 by selecting the product categories and selecting a “Remove selected” button 830.

Returning to FIG. 3, the user may also specify account settings, such as by selecting an “Account Settings” link 325. In some implementations, selecting the link 325 directs the user to a user interface 900 that the system provides to allow the user to specify account settings, as depicted by FIG. 9.

FIG. 9 is a display diagram 900 of a user interface 900 that the system provides to allow a user to specify account settings in some implementations. For example, the user may select whether sales reports generated for the user should include all advertisers or just the user's advertisers, by selecting radio button 905 or 910, respectively. In addition, the user may specify the time periods that are to be used for the charts and reports that are generated for the user. For example, the user may select whether advertisement page totals on a My Leads page are to include the current month's information, even if not all data for the month is available, last month's information, by selecting radio button 915 or 920, respectively. The user may also specify a time period 925 for which advertisements are to be included in account reviews and sales reports generated for the user. For example, the user may specify a time period by making month and year selections in a series of drop down boxes. The user interface 900 also allows the user to specify how far ahead the user is selling advertisements, via a drop down box 930. For example, the drop down box 930 indicates that the advertiser is selling advertisements 3 months ahead; that is, if today is September 1, the user is selling advertisements for its December issue.

The user interface 900 also allows the user to adjust the personal account information maintained for the user. For example, the user may specify a first name 935, last name 940, email address 945, and magazine 950. The user may also change his or her password via text boxes 955. The user interface 900 may also allow the user to change other account settings, including selecting one or more geographic areas to which the user's magazine is distributed and/or for which the user would like to target advertisements.

One skilled in the art will appreciate that alternative user interfaces may be presented for the features just described and/or that additional user interfaces may be presented for these and other features.

### 3. Recommendations

Based on the information obtained from the user and the information on advertisers and magazines stored by the system, the system may generate recommendations for the user. For example, the system may analyze the data and identify for each user advertisers that are not currently running advertisements in the user's magazine, but that should be.

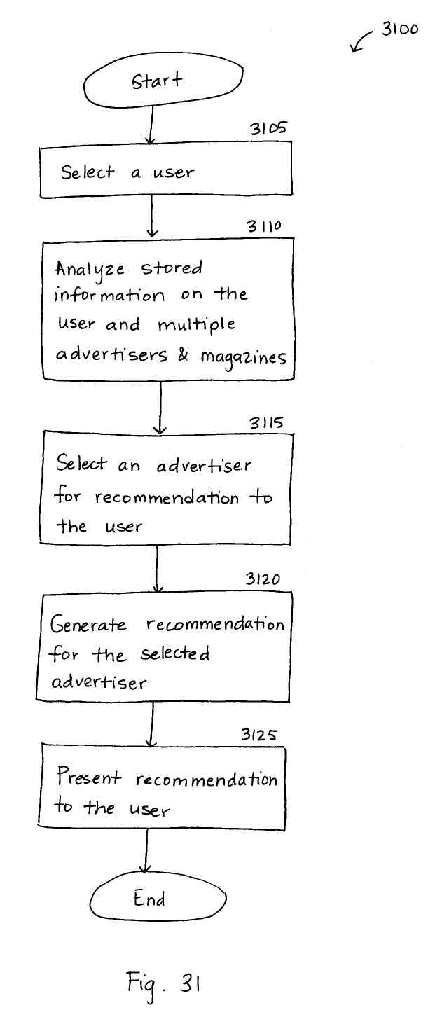

FIG. 31 is a flow diagram of a suitable process 3100 for generating a recommendation for a user. At a block 3105, the system selects a user for which recommendations are to be generated. For example, recommendations may be generated for each user on a periodic basis, such as daily, weekly, monthly, and so on.

At a block 3110, the system analyzes the information it has stored on the user, multiple advertisers, and multiple magazines, to determine which advertisers should be recommended to the user. In some implementations, the system runs a series of analyses on its data in order to generate one or more recommendations for a user. Each analysis may ask a specific question, such as “Is this brand advertising much more this month than it did over the preceding three months?” If the answer to the question is “yes,” the system may recommend an advertiser to the user as a sales lead.

In some implementations, to determine whether an advertiser is to be recommended to a user as a sales lead, the system applies some or all of the following tests: (1) Has the advertiser advertised in the user's magazine during the preceding three months? If not, the advertiser may be recommended as a sales lead. (2) Is the advertiser classified in one of the product categories specified in the user's personalized profile? If so, the advertiser may be recommended as a sales lead. However, if not, the advertiser is not eliminated from consideration; for example, the user may not have specified any product categories in his or her personalized profile, as described above. (3) Is the advertiser headquartered in or otherwise associated with one or more of the geographic regions specified in the user's profile? If so, the advertiser may be recommended as a sales lead. However, if not, the advertiser is not eliminated from consideration; for example, the user may not have specified any geographic regions in his or her profile.

In addition, the system may apply some or all of the following tests: (4) Has the advertiser run advertisements in magazines in the user's editorial category, but not in the user's magazine? If so, the advertiser may be recommended as a sales lead. (5) Is the number of advertisement pages run by the advertiser in the user's competitive set significantly higher than the average number of advertisement pages run by the advertiser in the preceding three months? If so, the advertiser may be recommended as a sales lead. (6) Has the advertiser advertised in other magazines with a target demographic that matches the target demographic of the user's magazine, even if the advertiser has not advertised in the user's competitive set? If so, the advertiser may be recommended as a sales lead.

The system may also apply some or all of the following tests: (7) Even if the number of advertisement pages run by the advertiser in the user's competitive set is not significantly higher than the number of advertisement pages run by the advertiser in the preceding months, does the number of advertisement pages run by the advertiser in the user's competitive set in the current month exceed the average number of pages run by an advertiser in the user's competitive set in the preceding three months? If so, the advertiser may be recommended as a sales lead. (8) Has the advertiser been running advertisements in high-value positions, such as cover 2, cover 3, cover 4, before the table of contents, or on the masthead? Or, has the advertiser been running nonstandard creative unit advertisements? If so, the advertiser may be recommended as a sales lead.

At a block 3115, the system selects an advertiser for recommendation to the user based on the analysis it has performed. In some implementations, the system may require that an advertiser's score on a particular question, multiple questions, or all of the questions exceed a threshold score if the advertiser is to be recommended to the user as a sales lead. For example, advertisers whose cumulative score on all of the tests exceeds a predefined threshold score may be recommended to the user as sales leads. In some implementations, cumulative scores range from 60 to 100.

At a block 3120, the system generates a recommendation for the selected advertiser. In some implementations, the system generates the recommendations in a natural language format, using phrases and/or sentences written in ordinary language. For example, the system may use a template to generate a sentence, such as “Ad buying for {company name} is on a major upswing. Over the previous three months, they averaged {#} pages/month in your competitive set, but in {month name}, they jumped {percent change} to {#} pages.” One skilled in the art will appreciate that other automated queries and templates may be used to generate recommendations, and that recommendations may be generated in other ways.

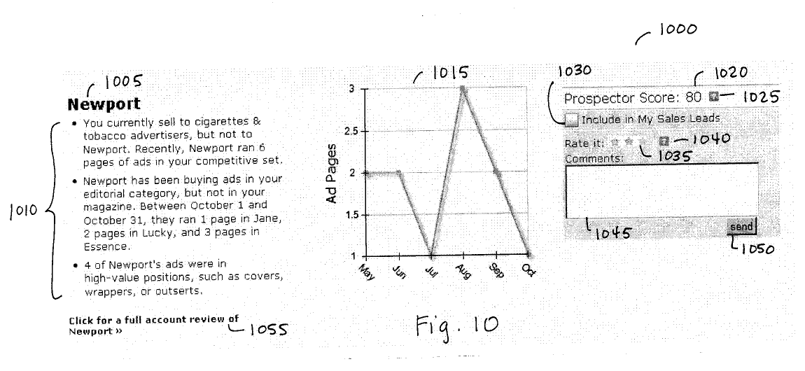

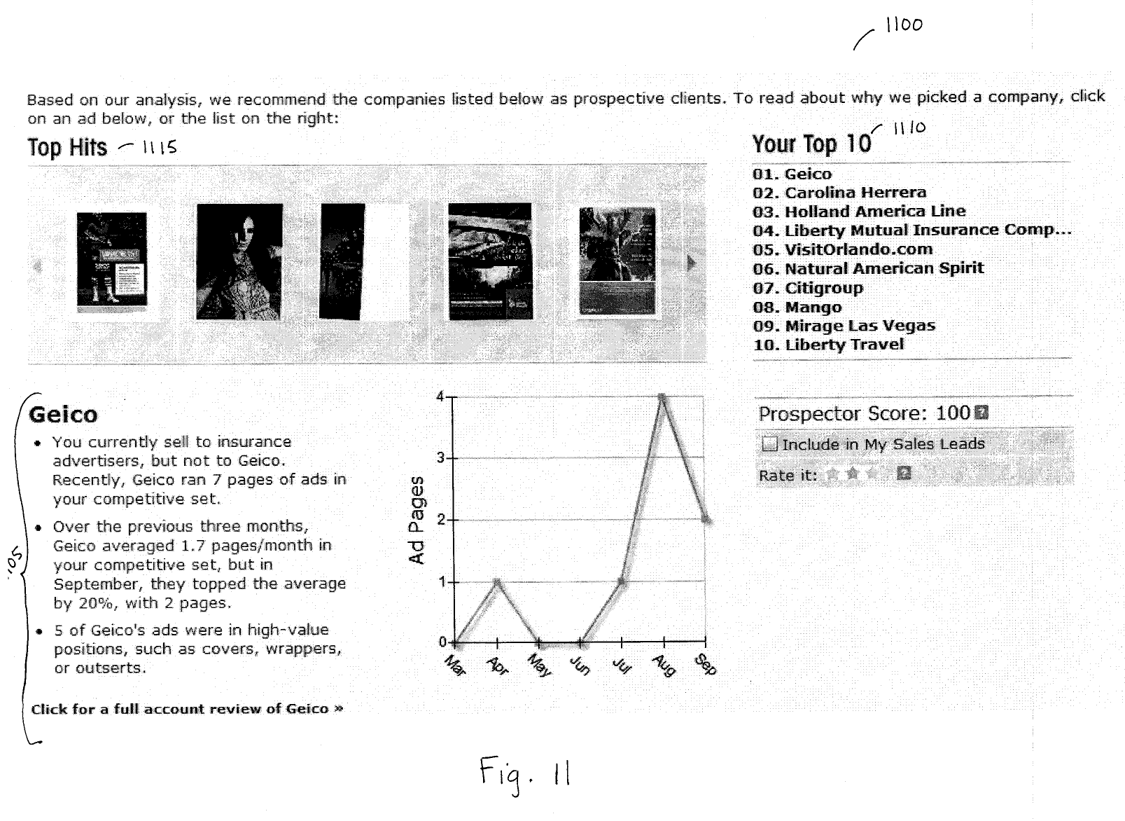

At a block 3125, the system presents the generated recommendation to the user. FIG. 10 is a display diagram of an example recommendation 1000 that the system may present to a user. The recommendation 1000 includes an indication 1005 of an advertiser, such as Newport, that the system is recommending to the user. The recommendation 1000 also includes a list 1010 of one or more statements that offer reasons that the advertiser 1005 has been recommended to the user. For example, in this example, Newport is recommended to the user for the following reasons: “You currently sell to cigarettes & tobacco advertisers, but not to Newport. Recently, Newport ran 6 pages of ads in your competitive set.”; “Newport has been buying ads in your editorial category, but not in your magazine. Between October 1 and October 31, they ran 1 page in Jane, 2 pages in Lucky, and 3 pages in Essence.”; and “4 of Newport's ads were in high-value positions, such as covers, wrappers, or outserts.”

Each of these statements 1010 may be generated by the system according to a template, as described above. For example, the templates for the statements above may be: “You currently sell to {product category}, but not to {company name}. Recently, {company name} ran {#} pages of ads in your competitive set.”; “{Company name} has been buying ads in your editorial category, but not in your magazine. Between {month name} {day} and {month name} {day}, they ran {#} page(s) in {magazine title}, {#} page(s) in {magazine title}, and {#} page(s) in {magazine title}.”; and “{#} of {company name}'s ads were in high-value positions, such as {high-value positions}.”

The recommendation 1000 also includes a graph 1015 of advertisement pages per month run by the recommended advertiser 1005. One skilled in the art will appreciate that this information may be presented in one or more other formats, including a bar graph or other format. In addition, the recommendation 1000 includes a score 1020 generated by the system for the advertiser, in reference to this particular user. For example, Newport receives a score 1020 of 80 for the depicted user. To access additional information about how scores are generated and/or a particular score, the user may select a “?” icon 1025.

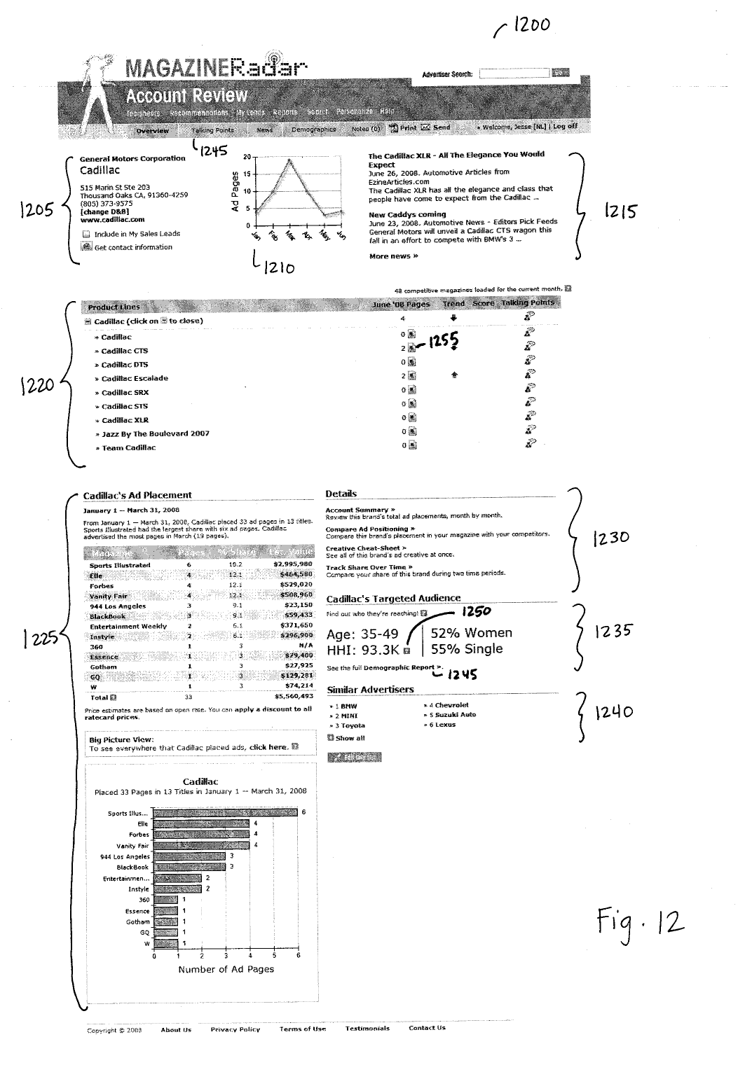

In addition, the recommendation 1000 includes a check box 1030 that the user may select to add the recommended advertiser 1005 to the user's favorites list, or My Leads list. My Leads lists are described in additional detail below. The recommendation 1000 also includes an opportunity for the user to rate 1035 the recommendation 1000. For example, if the user thinks that this is a good recommendation, the user may give it a 3-star rating; if the user thinks that this is a poor recommendation, the user may give it a 1- or 0-star rating. To access additional information about rating a recommendation, the user may select a “?” icon 1040. In addition, the user may type a comment 1045 about the recommendation to submit to the system and/or a system administrator, and select the “Send” button 1050 to send the comment to the system and/or the system administrator. The recommendation 1000 also includes a link 1055 to a full account review page of the recommended advertiser 1005. An account review page is described in detail below, in reference to FIG. 12.

Recommendations may be integrated into one or more system interfaces, may be delivered to the user via email, or may be presented to the user in a variety of other ways. FIG. 11 is a display diagram of an example user interface 1100 of the system that incorporates a recommendation 1105. The depicted recommendation 1105 is for Geico, and contains features similar to the recommendation 1000 depicted by FIG. 10. In addition, the user interface 1100 may present the user with a list 1110 of the top 10 advertisers that the system recommends for the user. The user may select a link to one or more of these advertisers, such as by clicking on an advertiser's name in the list 1100, to obtain more information about the advertisers. The user interface 1100 also displays images of magazine advertisements of the top 10 advertisers 1110 in a top hits section 1115. The user may select one of the displayed images of the magazine advertisements to access more information about the advertisement and/or the associated advertiser.

As described above in reference to FIG. 10, a user may access a full account review of a recommended advertiser, such as by selecting the link 1055 of FIG. 10. One skilled in the art will appreciate that an account review may be accessed by the user in a variety of other ways. FIG. 12 is a screen shot of an example user interface 1200 in which the system presents the user with an Account Review page for an advertiser. The Account Review page depicted by FIG. 12 includes contact information 1205 for a recommended advertiser, a graph 1210 of the number of advertisement pages run by the advertiser over time, news items 1215 associated with the advertiser, a list 1220 of the advertiser's product lines, information 1225 on the placement of the advertiser's advertisements, links 1230 to additional details on the advertiser, the advertiser's target demographic characteristics 1235, and a list 1240 of advertisers similar to the advertiser.

### 4. Talking Points

A user may determine, based on a recommendation or other information, that the user would like to initiate a telephone conference, in-person meeting, email, letter, or another communication with an advertiser. The system may generate “talking points” for the user on the desired advertiser. Talking points include a summary of salient facts that a user may want to mention during a communication with an advertiser.

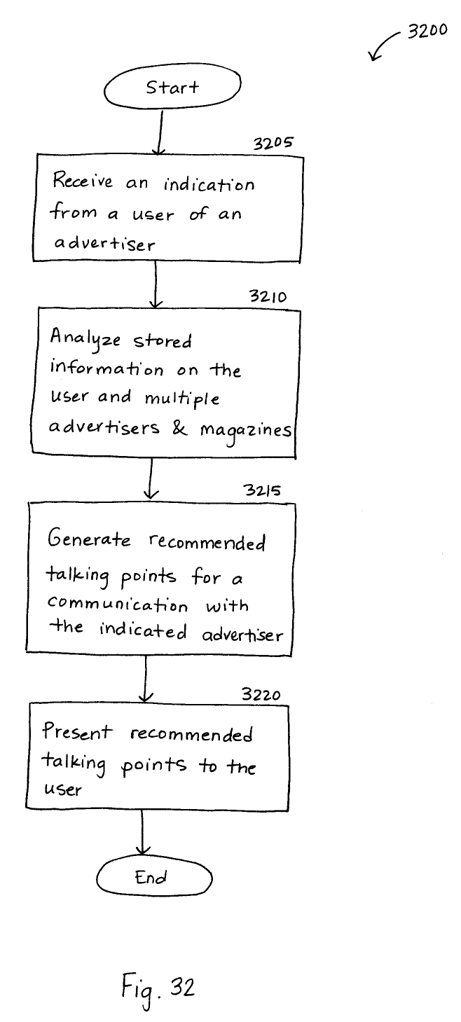

FIG. 32 is a flow diagram of a suitable process 3200 for generating talking points for an indicated advertiser. At a block 3205, the system receives an indication from a user of an advertiser for which recommended talking points are to be generated. For example, the user may select a talking points icon 2540 associated with an advertiser, as depicted by FIG. 25 and described below. Alternatively or additionally, the user may select a link associated with an advertiser on another system interface or service, or may otherwise select an advertiser for which recommended talking points are to be generated.

At a block 3210, the system analyzes the information it has stored on the user, multiple advertisers, and multiple magazines, to determine talking points that should be recommended for a communication between the user and the indicated advertiser. The system may run a series of analyses on its data, in a manner similar to that described in reference to Recommendations. Alternatively or additionally, the system may evaluate certain metadata stored on the user, one or more advertisers, and/or one or more magazines to determine recommended talking points. For example, the system may evaluate advertisement placement, brands advertised, demographic characteristics, and other information associated with the user, advertiser(s), and/or magazine(s).

At a block 3215, the system generates recommended talking points for a communication with the indicated advertiser, based on the analysis it performed at block 3210. Talking points may include a variety of information, including information about the advertiser's competitors, the separation the advertiser has received in other magazines, the placement of the advertiser's advertisements in other magazines (e.g., percentage of book), the brands on which the advertiser focused during a certain time period, high-value positions in which the advertiser has run advertisements, a peak advertising period of the advertiser, demographic characteristics targeted by the advertiser, when the advertiser plans its advertising budget, and other information. One skilled in the art will appreciate that talking points may be generated to include a variety of other information, and that the talking points may be presented to a user in a variety of manners.

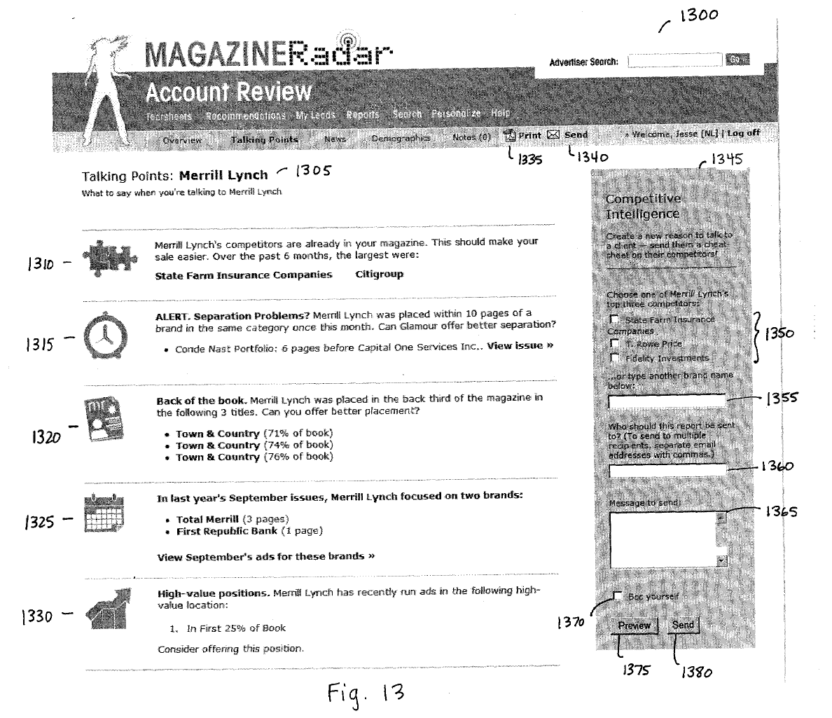

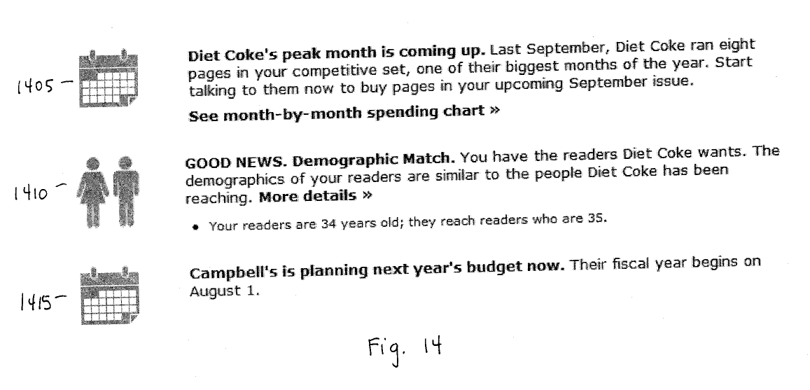

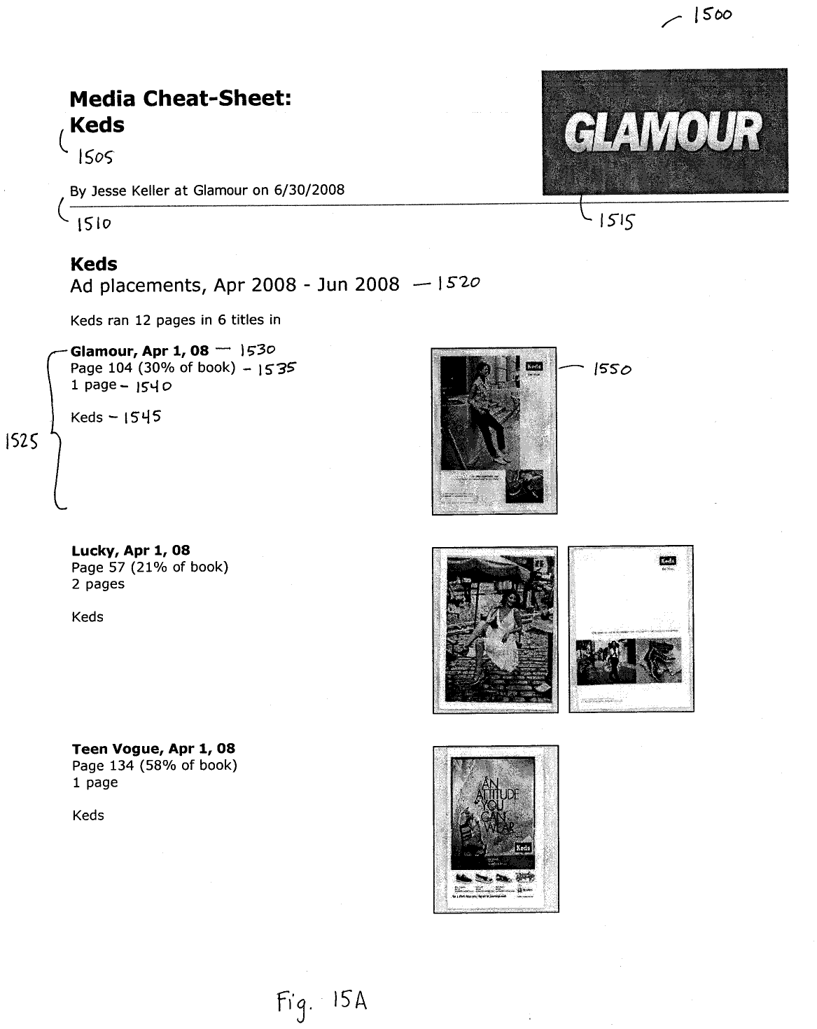

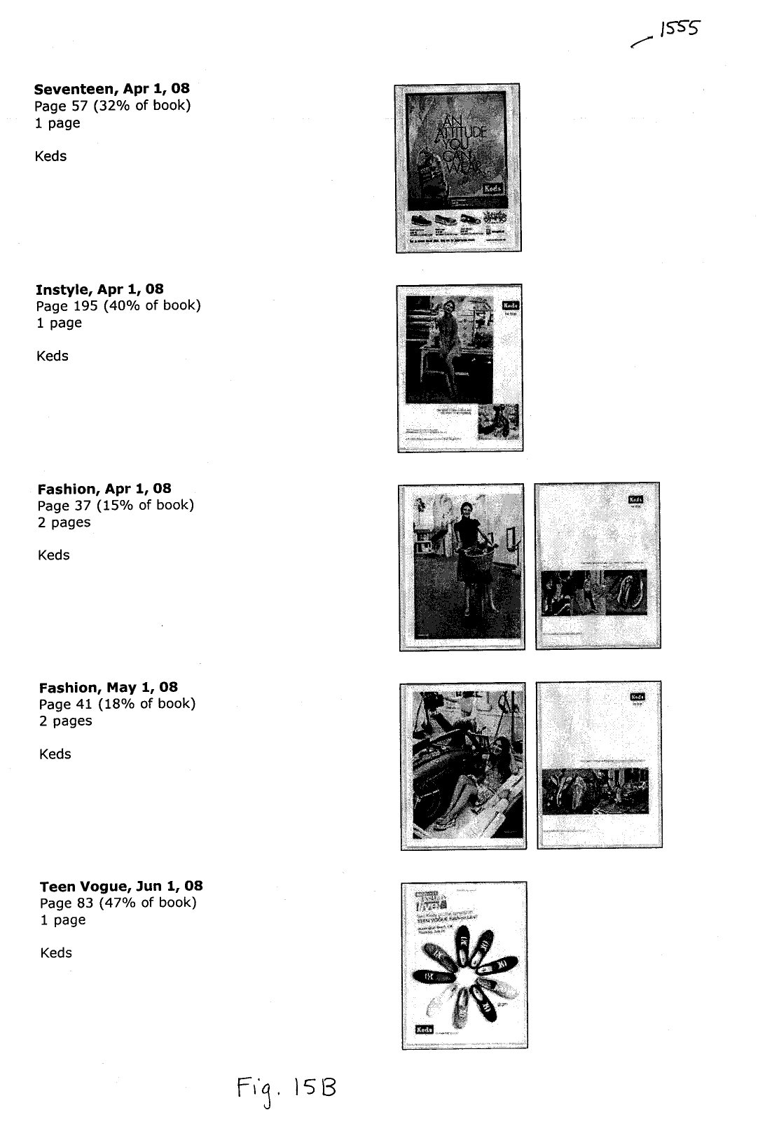

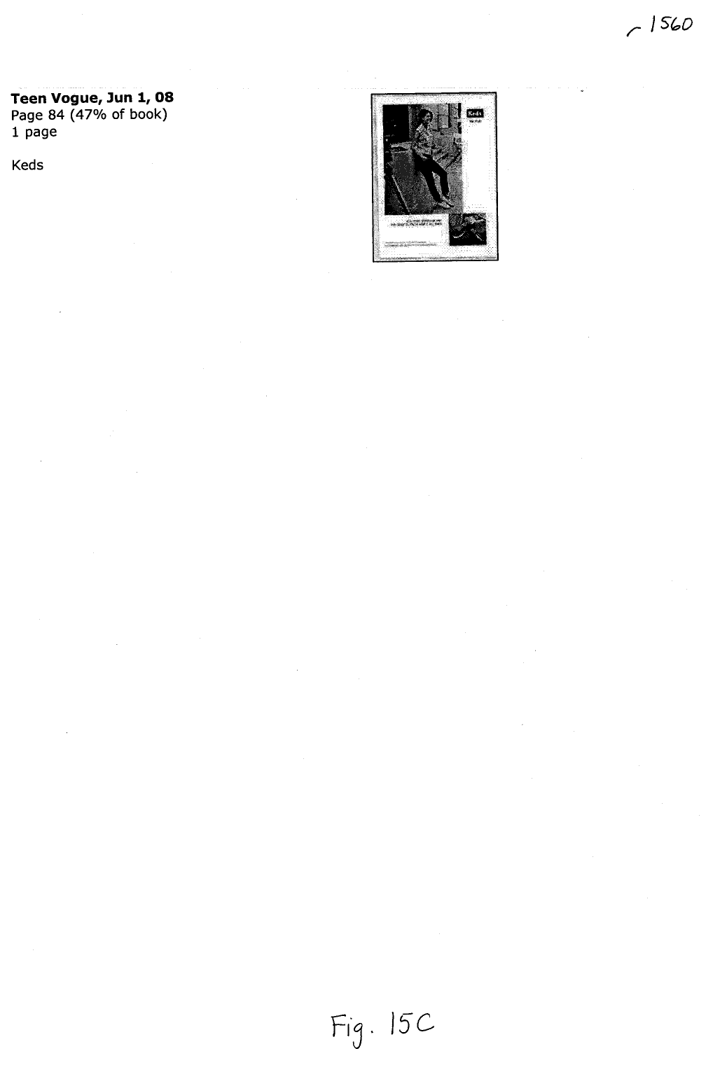

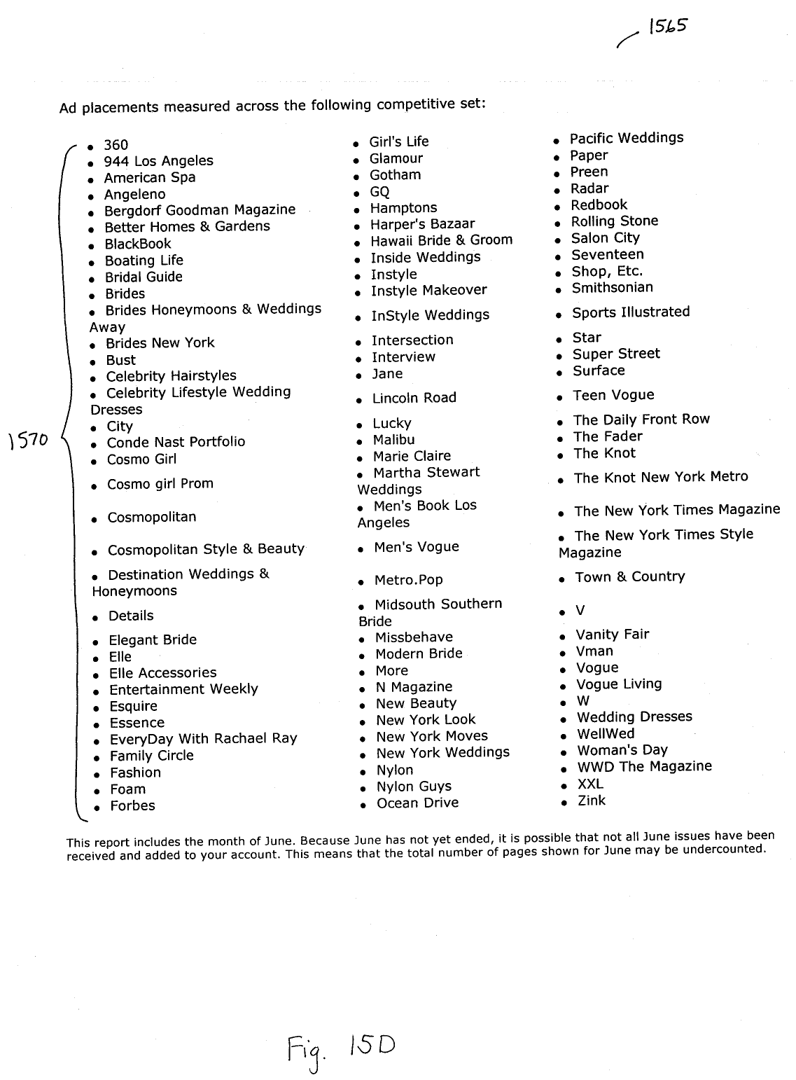

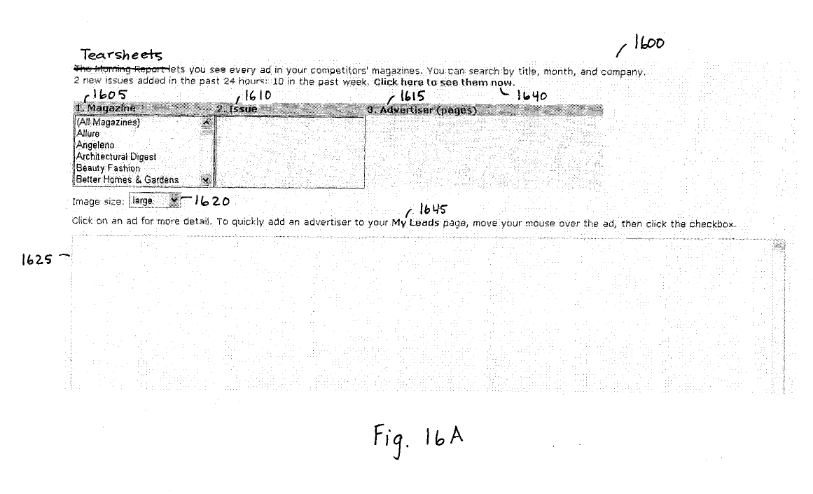

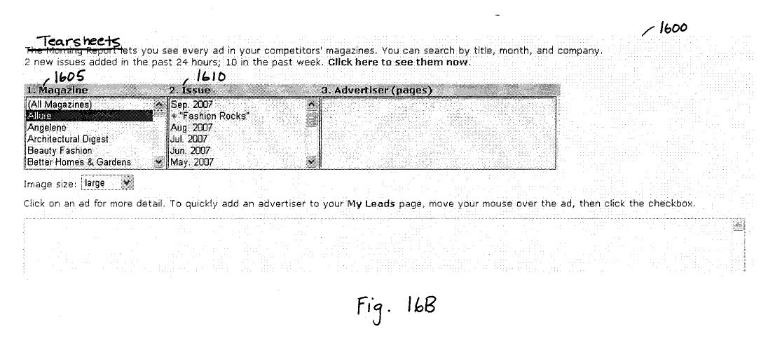

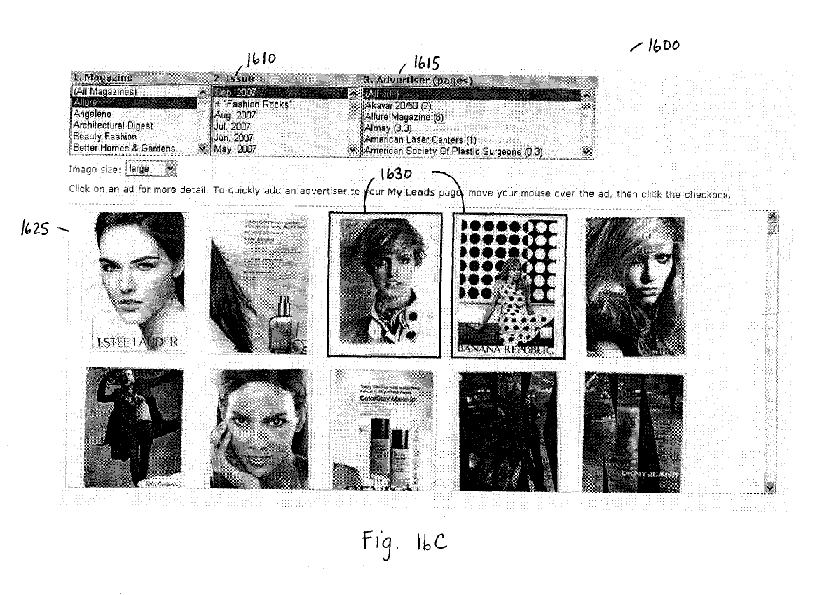

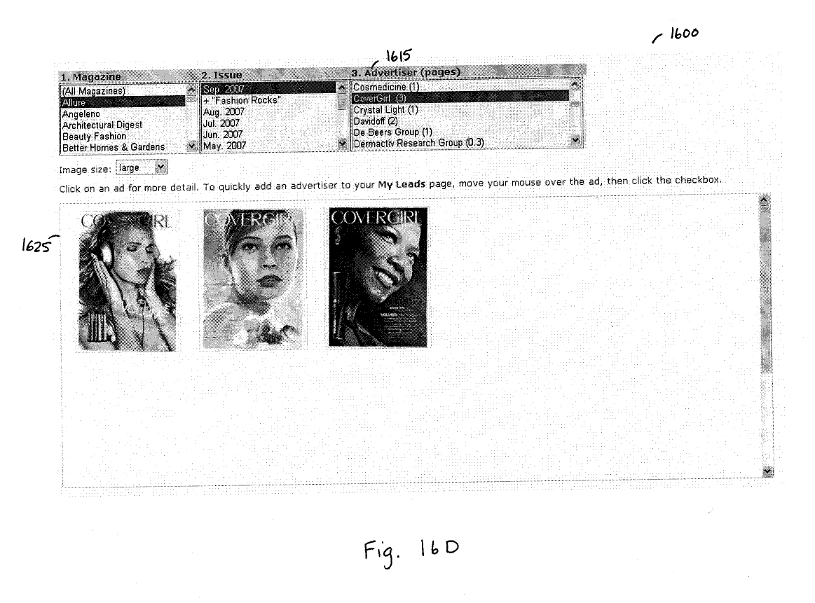

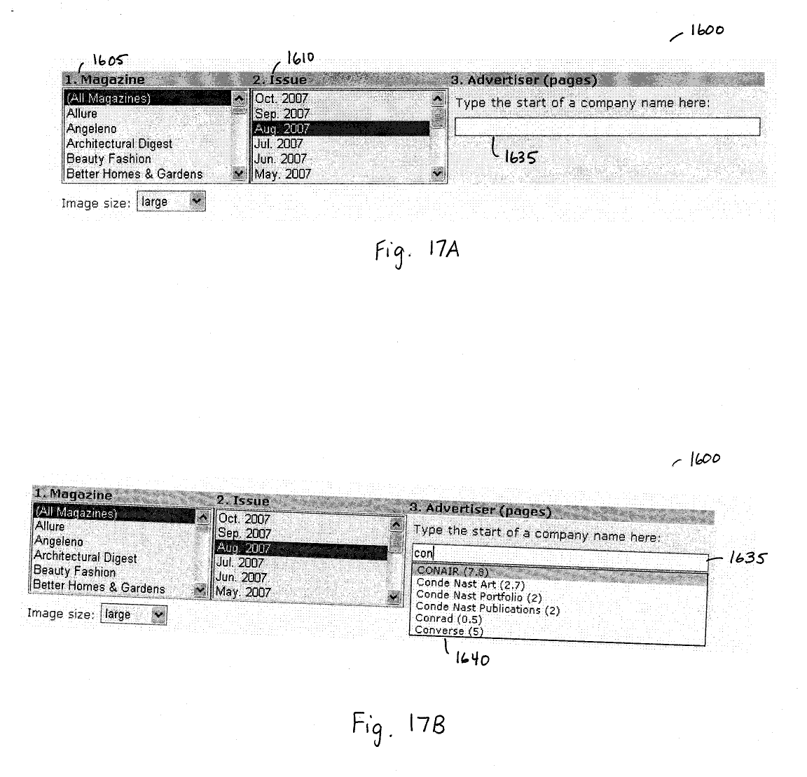

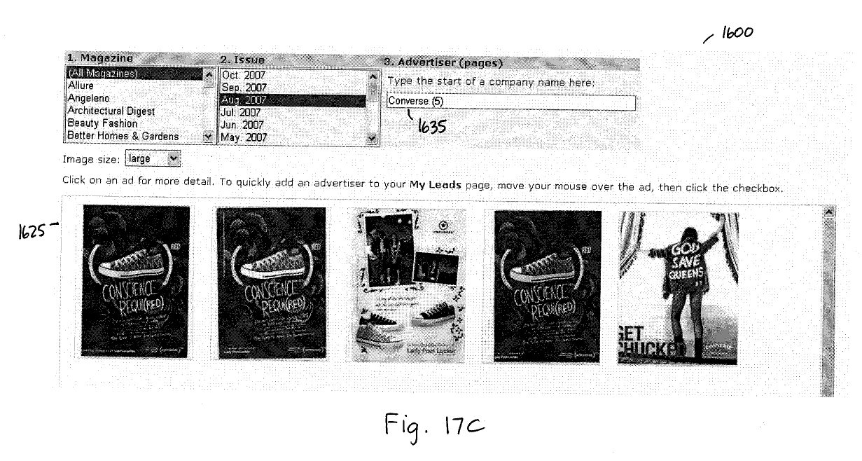

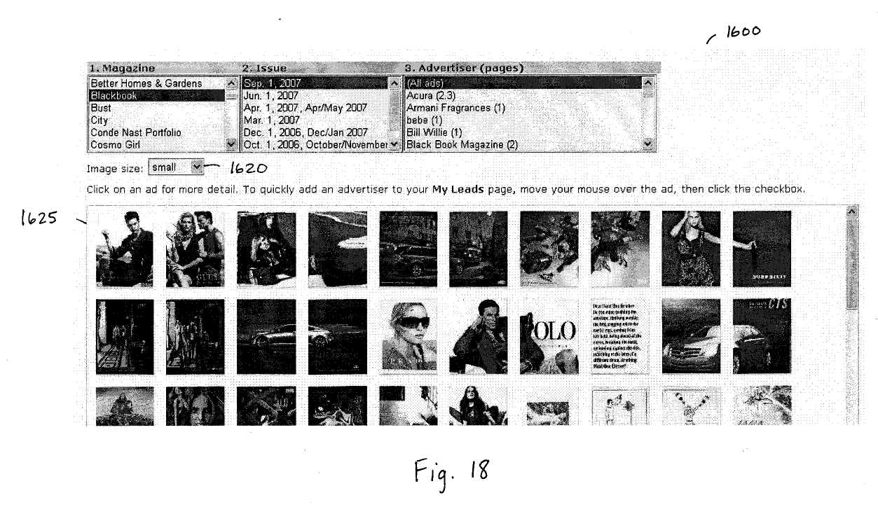

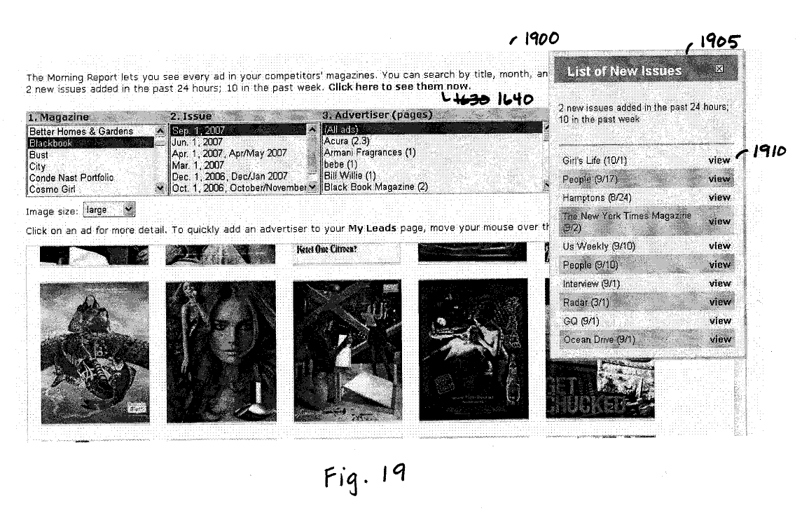

At a block 3220, the system presents the generated recommended talking points to the user. The system may display generated talking points to the user in a variety of ways, including via a user interface of the system web site, an email, or in another manner. FIG. 13 is a display diagram of a user interface 1300 used by the system to present talking points to a user in some implementations. The user interface 1300 includes an indication 1305 of the advertiser to whom the talking points are directed, and a series of talking points 1310-1330 that a user may want to mention during a communication with the advertiser 1305. FIG. 14 is a display diagram of additional talking points 1405-1415 that the system may present to a user, such as via user interface 1300 of FIG. 13.

Returning to FIG. 13, the user interface 1300 may allow the user to print and/or send the talking points to an email account, such as by selecting a “Print” icon 1335 or a “Send” icon 1340, respectively. In addition, the user interface 1300 depicts a “Competitive Intelligence” sidebar 1345 that allows the user to send a cheat-sheet to the advertiser on one or more of the advertiser's competitors. For example, a user may send a report about Pepsi to a representative at Coke, in an effort to gain credibility and favor with the Coke representative. The user may select a top competitor recommended by the system by selecting one of the check boxes 1350, or the user may enter the name of another of the advertiser's competitors into text box 1355. The user may enter one or more email addresses to which the cheat-sheet is to be sent, via text box 1360. In addition, the user may type a message to accompany the cheat-sheet into text box 1365. The user may select check box 1370 to Bcc a copy of the message 1360 and cheat-sheet to him- or herself. When the user is ready to send the message 1360 and the cheat-sheet, the user may preview and/or send the message 1360 and the cheat-sheet, by selecting a “Preview” button 1375 and/or a “Send” button 1380, respectively.

FIGS. 15A-D are display diagrams of an example cheat-sheet that may be generated by the system and sent to an advertiser and/or user. The cheat-sheet depicted by these Figures includes four pages 1500, 1555, 1560, and 1565. Page one 1500 of the cheat-sheet includes an indication 1505 of a brand, such as Keds, on which the cheat-sheet has been generated. In addition, page one 1500 includes a name of a user that generated the cheat-sheet, the title of the user's magazine, and a date on which the cheat-sheet was generated 1510, in addition to a logo or icon 1515 of the user's magazine. One skilled in the art will appreciate that a cheat-sheet may contain additional information about the user, the user's magazine, the advertiser on which the cheat-sheet has been generated, and/or the advertiser to which the cheat-sheet is to be sent.

The cheat-sheet includes one or more entries 1525 of advertisements run by the brand 1505. Each entry 1525 may include a variety of information, including the issue and magazine 1530 in which the advertisement ran, the page and/or percentage of the book 1535 at which the advertisement ran, the number of pages 1540 included in the advertisement, the brand and/or product line 1545 depicted in the advertisement, and one or more images 1550 of the advertisement, such as an image for each page of the advertisement.

In addition, the cheat-sheet may include an indication 1570 of the publications for which advertisement placements were measured, as depicted by FIG. 15D. For example, the cheat-sheet may detail the magazines included in a user's competitive set for which the advertisement placements were measured.

### 5. Tearsheets

In some implementations, the system provides the user with an interface for browsing digital images of magazine advertisements using a web browser, such as via a web site provided by the system. This interface may be referred to as Tearsheets. Tearsheets allow a user to browse advertisements from the user's magazine and other magazines, including magazines in one or more of the user's competitive sets. The user may interact with the Tearsheets in single-issue mode (i.e., a single magazine), all-issues mode (i.e., all magazines during a given time period), or another mode. Advertisements may be searched by magazine title, issue date, advertiser, and other parameters.

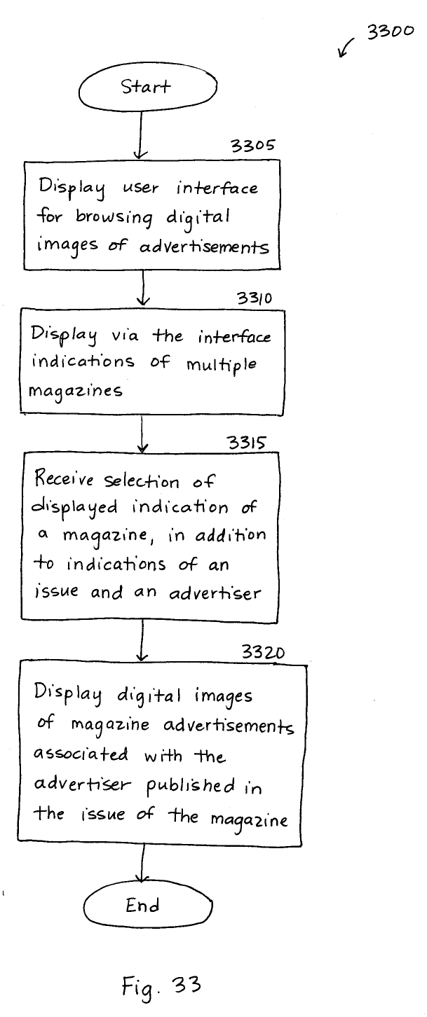

FIG. 33 is a flow diagram of a suitable process 3300 for browsing digital images of magazine advertisements. At a block 3305, the system displays a user interface for browsing digital images of advertisements. FIGS. 16A-D are a series of display diagrams of a Tearsheets user interface 1600 that the system may present for allowing a user to browse digital images of magazine advertisements. FIGS. 16A-D illustrate a user's interaction with Tearsheets 1600 in the single-issue mode.

Returning to FIG. 33, at a block 3310, the system displays via the user interface indications of multiple magazines for which digital images of magazine advertisements are available. At a block 3315, the system receives a user selection of a displayed indication of one or more magazines, in addition to receiving indications from the user of at least one issue and an advertiser for which digital images of magazine advertisements are to be displayed. As depicted by FIGS. 16A-D, a Tearsheets user interface 1600 may include a series of list boxes 1605-1615 from which a user may select a certain magazine, issue, and advertiser for which to view digital images of advertisements. List box 1605 allows the user to select a magazine; list box 1610 allows the user to select an issue of the magazine; and list box 1615 allows the user to select an advertiser that ran an advertisement in the issue of the magazine. In some implementations, the magazine titles included in list box 1605 are the magazine titles included one or more of the user's competitive sets. One skilled in the art will appreciate that magazines, issues, and advertisers may be selected by a user in a variety of other manners, including via icons, text boxes, or a combination of these and other ways.

In addition, Tearsheets 1600 allow the user to select an image size, such as large, medium, or small, via drop down box 1620, to specify the size in which the digital images are to be displayed. A display area 1625 is provided to display the advertisements selected by the user. Tearsheets 1600 also provide the user with a link 1640 that may be selected to view the newest issues in the user's competitive set that have been added to the system; this feature is described in additional detail below. The user may also access his or her My Leads page through a link 1645; the My Leads page is described in more detail below.

FIG. 16B is a display diagram of Tearsheets 1600 in which the user has selected a single magazine from the list box 1605. In the depicted example, the user has selected the magazine title “Allure.” Once the user has selected a magazine, the system presents the user with a list of issues of the magazine for which digital images of advertisements are available, such as via list box 1610. The list box 1610 may list available issues by publication date. In some implementations, if the magazine is a monthly title, the month and year of the issue are displayed; if the magazine is published more than once a month, the month, day, and year of the issue are displayed. The list box 1610 may also include one or more parasitic magazines, or “supplements,” that are distributed with regular magazine issues. For example, the list box 1610 depicts a “Fashion Rocks” supplement that was distributed with the September 2007 issue of Allure.

FIG. 16C is a display diagram of Tearsheets 1600 in which the user has selected an issue of the selected magazine from the list box 1610. In the depicted example, the user has selected the “September 2007” issue of Allure. Once the user has selected an issue of the magazine, the system presents the user with a list of advertisers that advertised in the selected issue, and for which digital images of advertisements are available, such as via list box 1615. The user may select to view a particular advertiser or all advertisers in the issue via list box 1615. In the depicted example, “(All ads)” is selected in the list box 1615. The user may have selected to view all of the advertisements, or this selection may be a default selection presented by the system when the list of advertisers is displayed in the list box 1615.

Returning to FIG. 33, at a block 3320, the system displays digital images of magazine advertisements associated with the indicated advertiser published in the indicated issue(s) of the indicated magazine(s). For example, returning to FIG. 16C, once an advertiser or all advertisers has been selected by the user, such as via the list box 1615, the system displays digital images of advertisements in display area 1625. In the depicted example, the display area includes all of the advertisements of the September 2007 issue of Allure. In some implementations, only a portion of the digital images of the magazine advertisements are displayed in the display area 1625 at once. The user may view other digital images of magazine advertisements by scrolling down in the display area 1625. In such implementations, the system achieves improved responsiveness, among other benefits, by loading new data on demand without resubmitting or reloading the user interface and/or the web page. For example, the displayed digital images may be updated behind the scenes using AJAX (i.e., asynchronous JavaScript and XML) programming techniques. Such techniques allow the system to operate more like a traditional desktop application than like a web page.

In addition, the system may display an indication 1630 of one or more advertisement pages comprising an advertisement selected by the user, as depicted by FIG. 16C. For example, when the user selects a particular digital image of a magazine advertisement, such as by clicking on the image, the system may display a distinguishable outline around each digital image that is included in the same advertisement as the selected digital image. For example, the displayed indication 1630 of FIG. 16C indicates that a two-page advertisement has been selected.

FIG. 16D is a display diagram of Tearsheets 1600 in which the user has selected a particular advertiser in the list box 1615. In the depicted example, the user has selected “CoverGirl.” In some implementations, the list of advertisers in the list box 1615 includes an indication of the number of advertisement pages run by each of the advertisers in the selected issue. For example, FIG. 16D indicates that, in the selected issue, Cosmedicine ran 1 page, CoverGirl ran 3 pages, Crystal Light ran 1 page, Davidoff ran 2 pages, De Beers Group ran 1 page, and Dermactive Research Group ran ⅓ page. When a user selects a particular advertiser from the list box 1615, the digital images displayed in the display area 1625 are dynamically updated to reflect the selected advertiser. For example, the display area 1625 includes digital images of the three advertisements run by CoverGirl in the September 2007 issue of Allure.

As described above, the user may also use Tearsheets to browse digital images of magazine advertisements in an all-issues mode. FIGS. 17A-C are a series of display diagrams of Tearsheets user interface 1600 in which the user has selected to browse in the all-issues mode. In the depicted example, the user has selected “(All Magazines)” from the list box 1605. Once the user has made this selection, the system presents the user with a list of issues for which digital images of advertisements are available, in the list box 1610. In some implementations, issues are listed by month and year in the all-issues mode. In the depicted example, the user has selected to view digital images for magazine advertisements that ran in August 2007.

In addition, once a user has selected an issue for which digital images of magazine advertisements are to be viewed, the user may type the name of an advertiser into a text box 1635. As the user begins typing the name of the advertiser, the system may display a list box 1640 of advertisers matching the entered text, as depicted by FIG. 17B. In addition, as described above, the system may display the number of pages of advertisements run by each advertiser during the selected issue. In the depicted example, the user has entered “con” into the text box 1635. In response, the system displays a list of advertisers 1640 that matches the entered text, including CONAIR, Conde Nast Art, Conde Nast Portfolio, Conde Nast Publications, Conrad, and Converse.

Once the user has selected an advertiser, such as by completing typing the name of the advertiser into the text box 1635 or selecting the advertiser from the list box 1640, the display area 1625 is updated to include digital images of magazine advertisements from the selected advertiser, as depicted by FIG. 17C.

As described above, the user may select to view the digital images of the magazine advertisements in the display area 1625 in different sizes, such as small, medium, and large. FIGS. 16C-D and 17C depict digital images displayed in a large size. Alternatively, FIG. 18 depicts digital images displayed in a small size, as indicated by the selection of “small” in drop down menu 1620 and the size of the images in the display area 1625.

As described above in reference to FIG. 16A, Tearsheets may be used to view the most recent magazine issues for which digital images of advertisements are available. For example, the user may view the newest issues in the user's competitive set. FIG. 19 is a display diagram of a Tearsheets user interface 1900 that displays a list 1905 of the newest issues in the user's competitive set for which digital images of advertisements are available. In some implementations, the list 1905 of the newest issues is displayed in response to a user action, such as selection of a link 1640 depicted by FIG. 16A. The list 1905 includes “view” links 1910 that the user may select to view the advertisements associated with a selected magazine.

In addition, Tearsheets may provide the user with an opportunity to add one or more advertisers of an advertisement to a favorites list, such as a My Leads list, which is described in detail below. For example, when a user mouses over or otherwise selects an advertisement displayed by a Tearsheets user interface, the system may display a checkbox 2010 for each advertiser 2015 associated with the advertisement. For example, the checkboxes may be displayed in a lower right corner of a last page of an advertisement. When a user selects a displayed checkbox 2010, the selected advertiser 2015 is added to the user's favorites list, such as a My Leads list.

### 6. Target Demographics

Target Demographics refer to measurements of the demographic characteristics of an audience reached by a company or brand. The system collects publicly-available data about each magazine's audience demographics. The system cross-references this information with data that has been collected on the magazines in which each company or brand was advertised, in order to calculate a measure of which demographic groups each company's or brand's advertisements reached. The system may present this target demographic in a variety of ways, including as a series of numbers and in natural language, using phrases and/or sentences written in ordinary language. Numbers computed by the system may include average household income (HHI), percentage of single/married readers, percentage of male/female readers, average reader age, and other numbers. In addition, the system may generate phrases and/or sentences by using a template, as described above in reference to Recommendations. In some implementations, the phrases and/or sentences may include information about the editorial categories in which the bulk of the advertisements are classified. For example, the system may generate a phrase such as “forty-something rich women into Business and Luxury magazines” as a description of the demographics of a company's audience.

In some implementations, the system makes determinations of target demographics based on weighted averages that account for both the number of advertisement pages run in each magazine and the (publicly available) circulation of the magazine. For example, target demographics may be determined in the following manner:
For each company, generate or access a list of the magazines in which the company advertises.
For each magazine in which a company advertises, average the percentage male readership of the magazine to generate the company's target gender demographic.
Weight the average by circulation numbers for the most recent year available.
Generate weighted averages for gender, age, household income (HHI), net worth, and marital status.
Generate weighted standard deviations for age and HHI, to determine how broad the age range is to which the company advertises.
Store the number of magazines and the editorial categories in which the company advertises, to determine the size of the data set.
Exclude companies if at least 80% of the magazines in which the company advertised do not have available demographic data.

In some implementations, target demographics are available to the user on various system web site interfaces, such as an Account Review page and a Demographic Detail page. FIG. 12, described above, depicts an Account Review page into which the system has incorporated target demographics 1235. In the example depicted by FIG. 12, the system indicates that Cadillac's targeted audience has an age range of 35-49, an HHI of 93.3 K, 52% of its readers are women, and 55% of its readers are single.

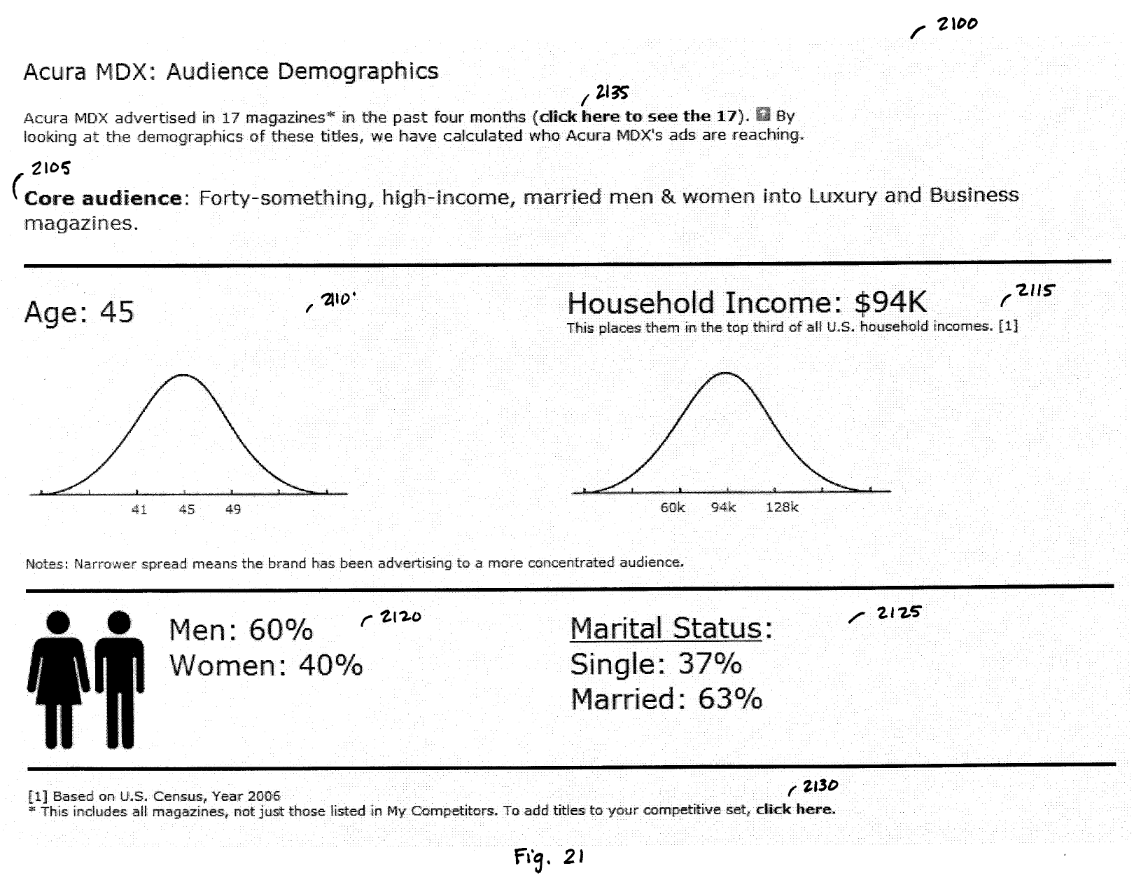

A user may access a more detailed demographic report on a company or brand in a variety of ways, such as by selecting a “Demographic Report” link 1245 depicted by FIG. 12. FIG. 21 is a screen shot of an example user interface 2100 for presenting a demographic report for an advertiser. The demographic report 2100 depicted by FIG. 21 includes a description 2105 of a core audience that the advertiser reaches, in addition to information regarding the audience's age 2110, household income 2115, gender 2120, marital status 2125, and other information. In addition, the demographic report 2100 includes a link 2130 by which the user can add the magazines in which the advertiser has advertised to the user's competitive set, and a link 2135 by which the user can see a list of the magazines in which the advertiser has advertised.

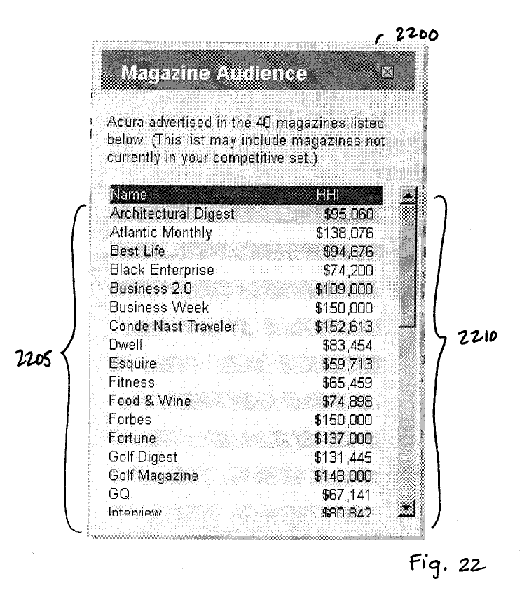

In addition, the user may access additional demographic information on a company or brand, such as from an Account Review page depicted by FIG. 12 or another user interface. For example, the user may select a link 1250 on the Account Review page depicted by FIG. 12 to view a more detailed representation of the household income of the advertiser's audience. FIG. 22 depicts a screen shot of an example user interface 2200 used to present detailed information regarding the household income of an advertiser's audience. In the example depicted by FIG. 22, the user interface 2200 includes a list 2205 of the magazines in which the advertiser advertised, in addition to the corresponding household income 2210 of the magazines' audiences.

One skilled in the art will appreciate that target demographics may be incorporated into the system web site and/or services in a variety of other ways. For example, target demographics may be integrated into Recommendations and Talking Points, each of which is described above.

### 7. Other System Features

a. AdStrip

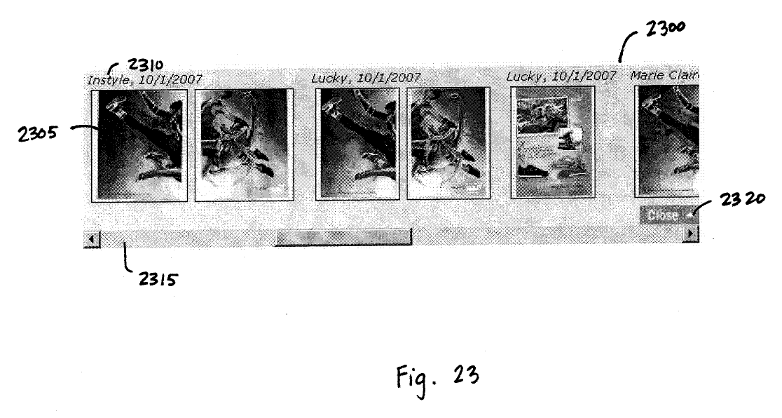

The system includes an advertisement strip, referred to as the “AdStrip,” that may be incorporated into various system user interfaces. FIG. 23 is a screenshot of an AdStrip 2300 that may be presented to the user for browsing advertisements. In the example depicted by FIG. 23, the AdStrip 2305 includes a series of thumbnail digital images of magazine advertisements 2305, in addition to information 2310 about where and when the advertisement was published, such as an indication of a magazine and issue date. The AdStrip 2305 includes a scroll bar 2315 that may be used to scroll through the advertisements in the AdStrip, and a close button 2320 that may be used to exit the AdStrip. One skilled in the art will appreciate that an advertisement strip may be implemented in additional ways, and include more or fewer features than the AdStrip depicted by FIG. 23.

The AdStrip may be presented by the system in a variety of ways, such as by “sliding out” with a windowshade animation. For example, when a user selects a show advertisements icon 1255 on an Account Review page, such as that depicted by FIG. 12, the system may slide the AdStrip out horizontally or vertically over the current user interface. In some implementations, selecting a thumbnail digital image of a magazine advertisement 2305 displays an enlargement of the selected advertisement in an AdViewer, as described below.

b. AdViewer

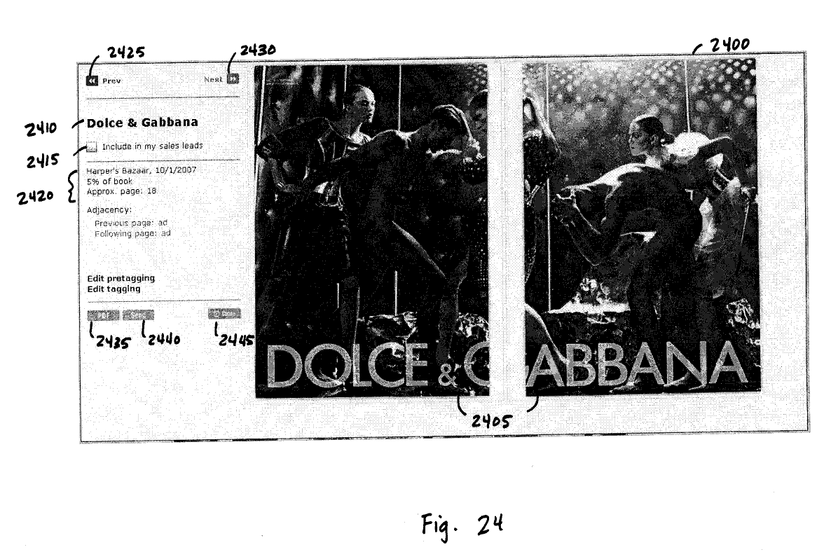

The system includes an advertisement viewer, referred to as the “AdViewer,” that may be incorporated into various system user interfaces. FIG. 24 is a screenshot of an AdViewer 2400 that may be presented to the user for viewing an advertisement. In the example depicted by FIG. 24, the AdViewer 2400 includes digital images of one or more advertisement pages 2405. In addition, the AdViewer 2400 includes an indication of the advertiser 2410 associated with the advertisement 2405 and information 2420 about the advertisement, including the magazine and issue that carried the advertisement, the placement of the advertisement (e.g., percentage of book), and the approximate page on which the advertisement was published. The AdViewer 2400 also includes a checkbox 2415 that allows a user to include the advertiser 2410 in the users My Leads, or favorites list, as described below.

The user may browse advertisements in the AdViewer 2400 by selecting the previous 2425 and next 2430 buttons. In addition, the user may generate a PDF of the advertisement by selecting a “PDF” button 2435 or send the advertisement to another user by selecting a “Send” button 2440. In some implementations, when the system generates a PDF or sends an advertisement on behalf of the user, the system brands the PDF or email with a logo and/or other information associated with the user's company. When a user selects the “Send” button 2440, the system may display prompts for additional information, such as a name and email address of a person to whom the advertisement is to be sent. In some implementations, the user may add a personal message to be included in an email sent by the system. The user may close the AdViewer by selecting “Close” button 2445 or taking another action.

The AdViewer may be displayed by the system in a variety of ways, including in response to a user action. For example, the system may display the AdViewer when the user selects an advertisement in a Tearsheets user interface or selects a thumbnail of the advertisement 2305 in an AdStrip. One skilled in the art will appreciate that the AdViewer may be presented by the system in a variety of other ways.

c. My Leads

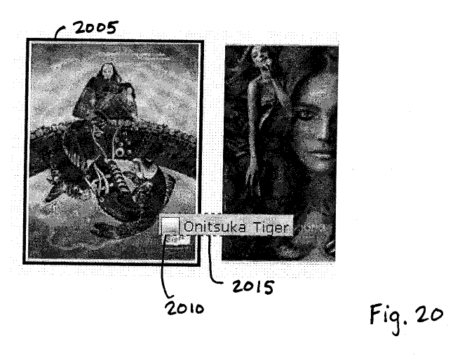

The system maintains a “favorites list” of advertisers for each user, which is referred to as a My Leads list. The system may present the user with a variety of opportunities to add advertisers to the user's My Leads list. For example, the system may display a checkbox or another selection opportunity when the advertiser is displayed to the user via a recommendation, a talking point, and/or an alert. In addition, the system may display a checkbox or another selection opportunity when an advertisement is displayed or selected by a user in a Tearsheets user interface, as described above in reference to FIG. 20. When a user selects a checkbox or other selection opportunity, the system adds the selected advertiser to the user's My Leads list.

FIG. 25 is a screen shot of an example user interface 2500 for presenting a My Leads list to a user. In the example depicted by FIG. 25, the information presented in the My Leads user interface 2500 includes company, brand, or advertiser name (i.e., “Product Lines”) 2505, advertiser type 2510 (e.g., current “Account” or prospective “Lead”), number of pages 2515 advertised during a depicted time period (e.g., a current month), trend 2520 in advertising spending (as measured by pages advertised), recommendation score 2525, links 2530 to talking points pages for advertisers, and links 2535 to remove the advertisers from the user's My Leads list. In some embodiments, the advertising trend 2520 is depicted by an arrow. A faded or gray arrow may indicate a small change, while a darker or colored arrow may indicate a larger change. The absence of an arrow may indicate “no change.” A user may star 2550 or otherwise select advertisers on the My Leads list, search 2555 for a particular advertiser on the list, and see additional advertisers by selecting links 2560 and 2565.

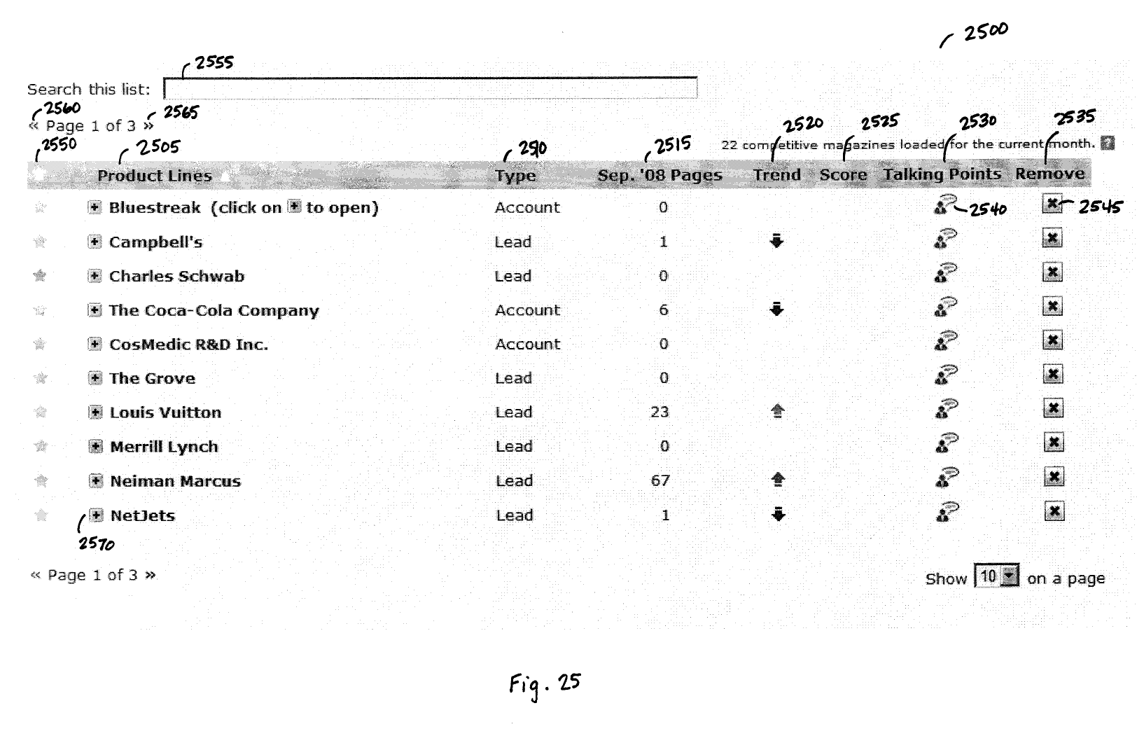

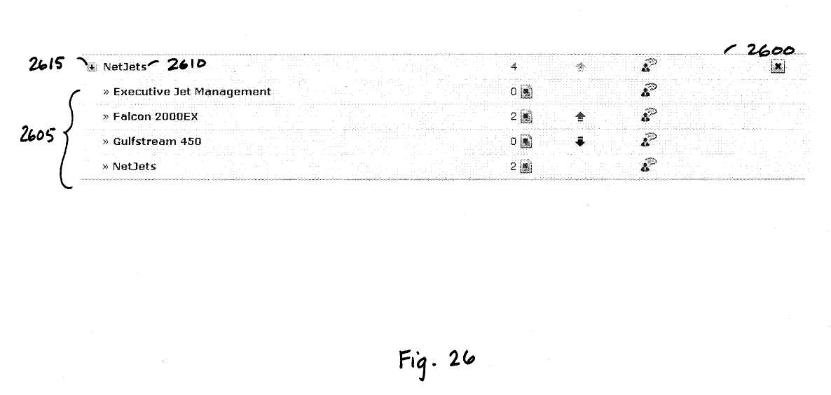

Each advertiser on a user's My Leads list may include multiple brands. In the example depicted by FIG. 25, a user may select an expand icon 2570 associated with an advertiser to see a list of brands associated with the advertiser. FIG. 26 is a screen shot of an example user interface 2600 that the system may use to present information on multiple brands associated with an advertiser. In the example depicted by FIG. 26, the system displays a list 2605 of the brands associated with an advertiser 2610, in addition to displaying some or all of the information depicted by FIG. 25, delineated by brand. The user may select a collapse icon 2615 to return to viewing information on the advertiser 2610 as a whole.

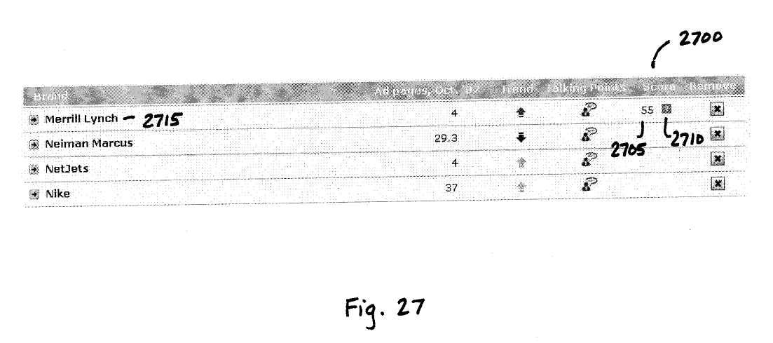

As described above in reference to FIG. 25, the My Leads user interface may include a recommendation score 2525. In some implementations, the system may display a recommendation score for advertisers and/or brands recommended to the user by the system. FIG. 27 is a screen shot of a My Leads user interface 2700 that displays a score 2705 associated with an advertiser 2715. In the example depicted by FIG. 27, the system may recommend Merrill Lynch 2715 to the user, but not recommend the other depicted advertisers. An advertiser may not be recommended by the system, for example, if the advertiser is already advertising in the user's magazine, if the advertiser does not seem to be a good fit for the user's magazine, or for a variety of other reasons.

A user may access additional information about a recommendation score 2705, such as by selecting a question mark icon 2710 associated with the recommendation score 2705. FIG. 28 is a screen shot of an example explanation 2805 of a recommendation score that may be presented via a My Leads interface 2800 or other system interface. As described above in reference to Recommendations, the explanation 2805 may include one or more sentences and/or phrases that explain why an advertiser is recommended for the user.

d. Reports

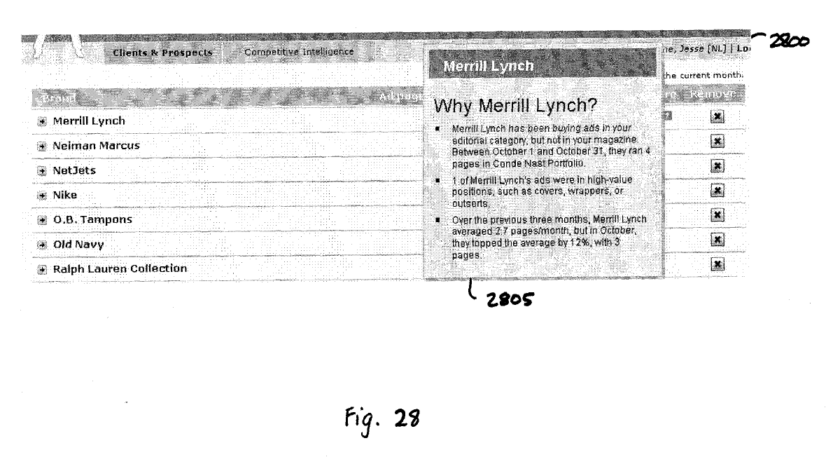

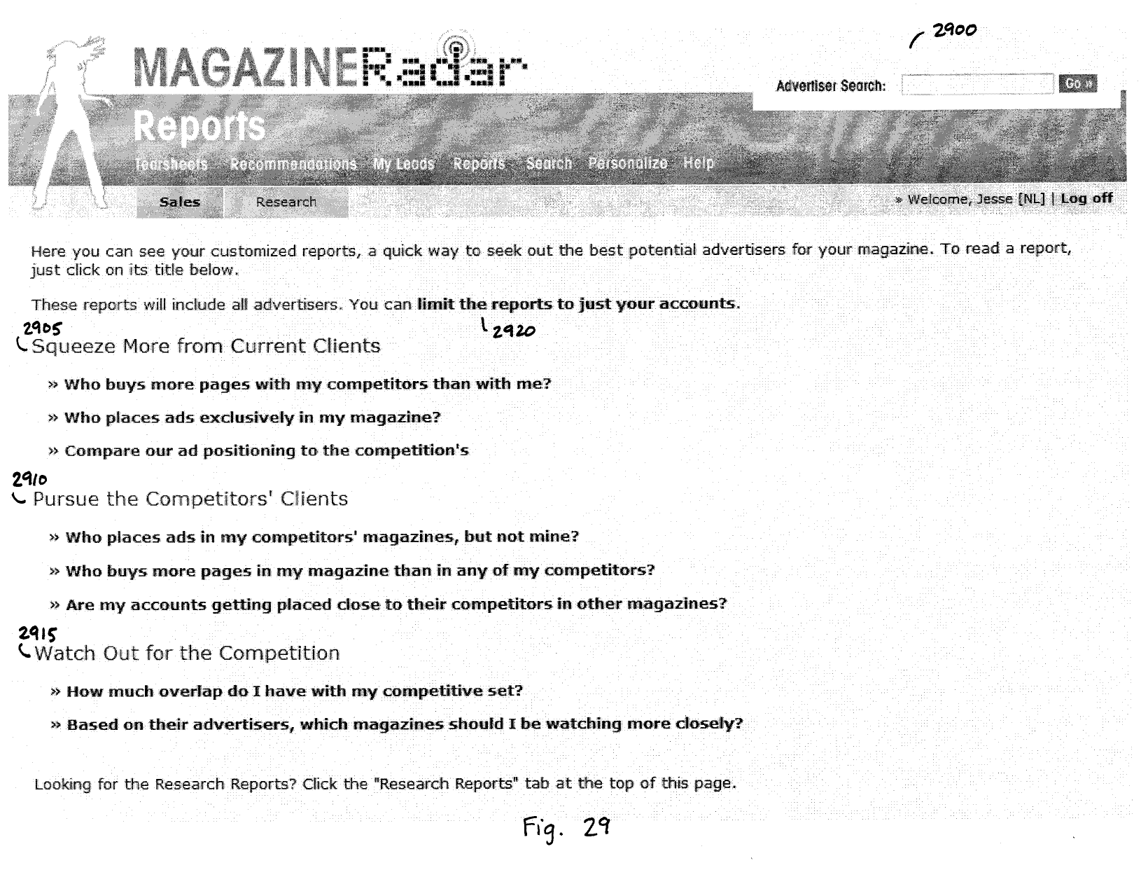

The system provides users with a variety of reports relating to current advertisers, prospective advertisers, competing magazines, and other reports. FIG. 29 is a screen shot of a user interface 2900 that displays several available reports. In the example depicted by FIG. 29, a user can view reports 2905 on its current advertisers, including which advertisers buy more advertisement pages with competing magazines, which advertisers place advertisements exclusively with the user's magazine, a comparison of the user's advertisement positioning in comparison with competing magazines, and other reports. A user can also view reports 2910 on prospective clients, including which advertisers place advertisements in competing magazines but not in the user's magazine, which advertisers buy more advertising pages in the user's magazine than in competing magazines, whether any of the user's advertisers are getting placed too close to their competitors in other magazines, and other reports. In addition, a user can view reports 2915 on its competitors, including how much overlap the user's magazine has with the magazines in its competitive set, which magazines the user should be watching more closely based on its advertisers, and other reports. The reports generated by the system may include all advertisers in the system databases, or the user can select 2920 to limit the reports to advertisers in the user's competitive set.

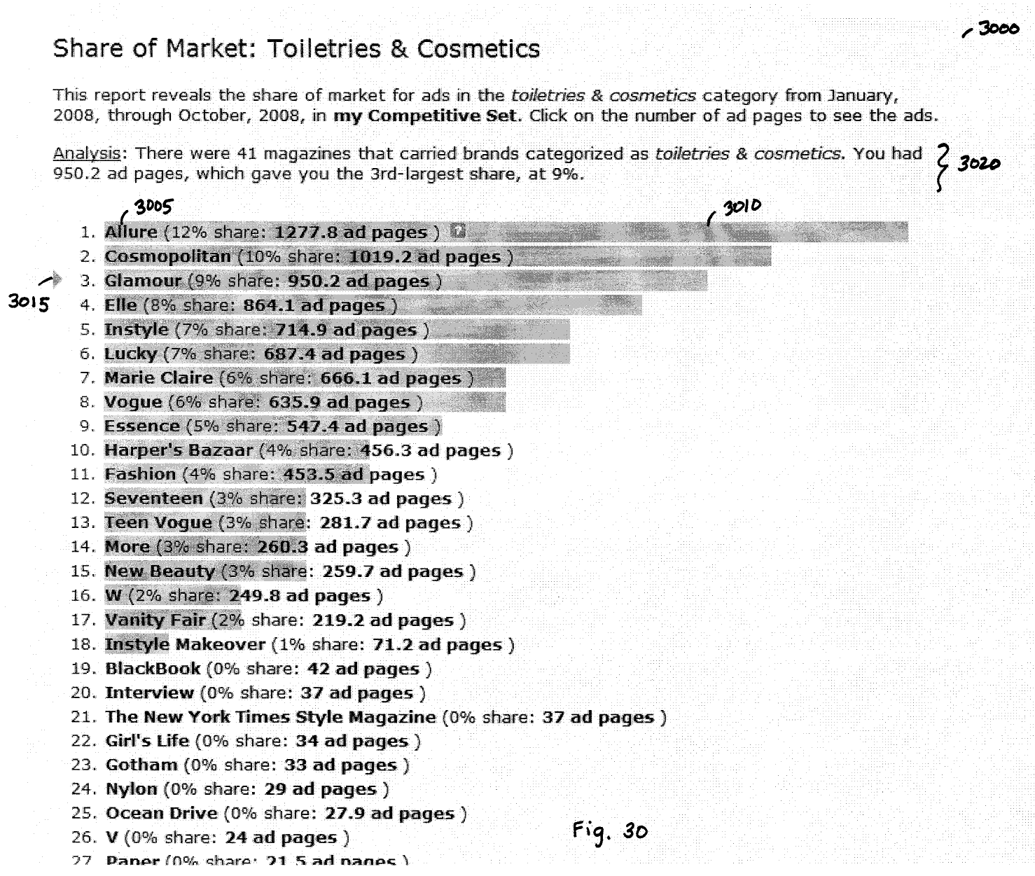

FIG. 30 is a screen shot of an example report 3000 that may be generated by the system. In the example depicted by FIG. 30, the report relates to the market share had by magazines in a particular advertising category, such as toiletries and cosmetics. The report 3000 presents information 3005 on magazines that have a share of the market, including magazine name, percentage share, and number of advertisement pages. In addition, the report 3000 includes a graphical representation of the market share of each magazine, such as a bar 3010 representative of a bar graph. The report 3000 also includes an indication 3015 of which magazine is associated with the user. In addition, the report 3000 includes an analysis 3020 of the market and the user's share of the market. As described above in reference to Recommendations, the analysis may be generated in phrases and/or sentences written in ordinary language, such as by filling in a template. One skilled in the art will appreciate that a variety of reports may be generated by the system, in addition to the report depicted by FIG. 30.

### Conclusion

One skilled in the art will appreciate that the described technology may be used in other ways and in combination with other methods and systems. For example, the described technology may be used to allow advertisers and advertising agencies to track their own advertisements. In addition, the described technology may be applied to other types of media, including newspaper, Internet, radio, television, multimedia, and other advertisements.

In general, the detailed description of implementations of the described technology is not intended to be exhaustive or to limit the described technology to the precise form disclosed above. While specific implementations of, and examples for, the described technology are described above for illustrative purposes, various equivalent modifications are possible within the scope of the described technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

Aspects of the described technology may be stored or distributed on computer-readable media, including magnetically or optically readable computer discs, hard-wired or preprogrammed chips (e.g., EEPROM semiconductor chips), nanotechnology memory, biological memory, or other data storage media. Indeed, computer implemented instructions, data structures, screen displays, and other data under aspects of the described technology may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Those skilled in the relevant art will recognize that portions of the described technology reside on a server computer, while corresponding portions reside on a client computer such as a mobile or portable device, and thus, while certain hardware platforms are described herein, aspects of the described technology are equally applicable to nodes on a network.

The teachings of the described technology provided herein can be applied to other systems, not necessarily the system described herein. The elements and acts of the various implementations described herein can be combined to provide further implementations.

Any patents, applications, and other references, including any that may be listed in accompanying filing papers, are incorporated herein by reference. Aspects of the described technology can be modified, if necessary, to employ the systems, functions, and concepts of the various references described above to provide yet further implementations of the described technology.

These and other changes can be made to the described technology in light of the above Detailed Description. While the above description details certain implementations of the described technology and describes the best mode contemplated, no matter how detailed the above appears in text, the described technology can be practiced in many ways. Details of the described technology may vary considerably in its implementation details, while still being encompassed by the described technology disclosed herein. As noted above, particular terminology used when describing certain features or aspects of the described technology should not be taken to imply that the terminology is being redefined herein to be restricted to any specific characteristics, features, or aspects of the described technology with which that terminology is associated. In general, the terms used in the following claims should not be construed to limit the described technology to the specific implementations disclosed in the specification, unless the above Detailed Description section explicitly defines such terms. Accordingly, the actual scope of the described technology encompasses not only the disclosed implementations, but also all equivalent ways of practicing or implementing the described technology.

While certain aspects of the invention are presented below in certain claim forms, the applicant contemplates the various aspects of the invention in any number of claim forms. For example, while only one aspect of the invention is recited as a means-plus-function claim under 35 U.S.C sec. 112, sixth paragraph, other aspects may likewise be embodied as a means-plus-function claim, or in other forms, such as being embodied in a computer-readable medium. (Any claims intended to be treated under 35 U.S.C. §112, ¶6 will begin with the words “means for”.) Accordingly, the applicant reserves the right to add additional claims after filing the application to pursue such additional claim forms for other aspects of the invention.

I/We claim:

1. A computing system for facilitating management of advertising accounts, the system comprising:
a storage component for storing information related to multiple users and multiple advertisers;
a recommendation generation component for generating recommended advertisers for a publication associated with a user, the recommendation generation component comprising:
a selection component for selecting one or more of the multiple advertisers for recommendation to the user, wherein the one or more advertisers are selected based on stored information related to the user and the stored information related to the multiple advertisers; and
an analysis component for generating recommendations for the selected advertisers based on the stored information related to the user and the stored information related to the multiple advertisers, wherein each of the recommendations describes why one or more of the selected advertisers have been selected for recommendation to the user;
a discussion points generation component for generating recommended discussion points for a communication with an advertiser, the discussion points generation component comprising:
an input component for receiving from the user an indication of one of the multiple advertisers for which recommended discussion points are to be generated; and
an evaluation component for, in response to the received indication, generating recommended discussion points for a communication with the indicated advertiser, wherein the recommended discussion points are generated based on the stored information related to the multiple users and stored information associated with the indicated advertiser;
a display component for displaying:
the generated recommendations;
the generated recommended discussion points; and,
an interface for browsing digital images of magazine advertisements; and,
a digital magazine advertisement presentation component for presenting digital images of magazine advertisements to the user, the digital images of magazine advertisements including advertisements from publications that are not associated with the user, the digital magazine advertisement presentation component comprising:
an input component for receiving from the user via the displayed interface an indication of at least one magazine, an indication of an issue of the at least one magazine, and an indication of at least one advertiser; and
an output component for, in response to the received indications, displaying via the displayed interface digital images of magazine advertisements associated with the at least one advertiser published in the issue of the at least one magazine.

2. The system of claim 1, wherein each of the multiple advertisers advertises in one or more magazines, and wherein the publication of the user is a magazine published by a business organization for the user.

3. A computing system for generating recommended advertisers for a publication associated with a user, the system comprising:
means for storing information related to multiple users and multiple advertisers;
means for selecting one or more of the multiple advertisers for recommendation to a user, wherein the one or more advertisers are selected based on stored information related to the user and the stored information related to the multiple advertisers;
means for generating recommendations for the selected advertisers based on the stored information related to the user and stored information related to the selected advertisers, wherein each of the recommendations describes why one or more of the selected advertisers have been selected for recommendation to the user; and,
means for presenting the generated recommendations to the user.

4. The system of claim 3, wherein each of the multiple advertisers advertises in one or more magazines, and wherein the publication of the user is a magazine published by a business organization for the user.

5. The system of claim 3, wherein the recommendations are presented by using phrases or sentences in ordinary language.

6. The system of claim 3, wherein an advertiser is not selected for recommendation to the user if the advertiser has advertised in the publication associated with the user during a certain time period.

7. The system of claim 3, wherein an advertiser is not selected for recommendation to the user if the advertiser has already been recommended to the user.

8. The system of claim 3, wherein the stored information related to the user includes one or more categories of products advertised in the publication associated with the user, and wherein an advertiser is selected for recommendation to the user if the advertiser is classified in at least one of the one or more categories of the products advertised in the publication.

9. The system of claim 3, wherein the stored information related to the user includes an indication of one or more geographic areas covered by the publication associated with the user, and wherein an advertiser is selected for recommendation to the user if the advertiser is located in at least one of the one or more geographic areas covered by the publication.

10. The system of claim 3, wherein the stored information related to the user includes an editorial category of the publication associated with the user, and wherein an advertiser is selected for recommendation to the user if the advertiser has advertised in other publications in the same editorial category of the publication.

11. The system of claim 3, wherein the publication is a magazine, wherein the stored information related to the user includes target demographic characteristics of the publication associated with the user, and wherein an advertiser is selected for recommendation to the user if the advertiser has advertised in other magazines with similar target demographic characteristics of the publication.

12. The system of claim 3, wherein the stored information related to the user includes an average number of pages advertised by an advertiser in a competitive set associated with the user during a period of months prior to a current month, and wherein an advertiser is selected for recommendation to the user if the number of pages advertised by the advertiser in the competitive set associated with the user in the current month exceeds the average number of pages advertised by an advertiser in the competitive set associated with the user during the period of months prior to the current month.

13. The system of claim 3, wherein an advertiser is selected for recommendation to the user if the advertiser has been advertising in high-value positions in similar publications.

14. The system of claim 3, wherein the means for presenting the generated recommendations to the user comprises means for sending an email alert to the user, wherein the email alert includes the generated recommendations.

15. The system of claim 3, wherein the means for presenting the generated recommendations to the user comprises means for sending an email alert to the user, wherein the email alert includes one or more links to the generated recommendations.

16. A computer-readable storage medium comprising instructions for performing a method for generating recommended discussion points for a communication with an advertiser, the method comprising:
storing information related to multiple users and multiple advertisers;
receiving from a user an indication of one of the multiple advertisers for which recommended discussion points are to be generated;
in response to the received indication, generating recommended discussion points for a communication with the indicated advertiser, wherein the recommended discussion points are generated based on the stored information related to the multiple users and stored information associated with the indicated advertiser; and,
presenting the generated recommended discussion points to the user.

17. The computer-readable medium of claim 16, wherein each of the multiple advertisers advertises in one or more magazines, and wherein the user is associated with a magazine.

18. The computer-readable medium of claim 16, wherein at least one of the generated recommended discussion points relates to:
one or more competitors of the indicated advertiser, and wherein the one or more competitors advertise in a publication associated with the user;
a number of pages of separation between the indicated advertiser and a competitor of the indicated advertiser in a publication;
the placement of the indicated advertiser's advertisements in one or more publications;
one or more brands of the indicated advertiser on which the indicated advertiser focused during a certain time period; or
one or more high value positions in which the indicated advertiser has recently run advertisements in one or more publications.

19. The computer-readable medium of claim 16, wherein at least one of the generated recommended discussion points relates to:
a number of pages of advertisements that the indicated advertiser ran in a competitive set associated with the user during a given time period;
a peak advertising period for the indicated advertiser;
one or more demographic characteristics targeted by the indicated advertiser; or
a time period during which the indicated advertiser plans its advertising budget.

20. The computer-readable medium of claim 16, wherein the method further comprises allowing the user to send a report to the indicated advertiser about one or more of the indicated advertiser's competitors.

21. A computer-implemented method of presenting digital images of magazine advertisements to a user, the method comprising:
displaying to a user an interface for browsing digital images of magazine advertisements, wherein the digital images of magazine advertisements include advertisements from magazines not associated with the user, and wherein the interface is displayed to the user via a display of a computer system of the user;
displaying via the interface indications of multiple magazines for which digital images of magazine advertisements are displayable, wherein the indications of the multiple magazines include indications of magazines that are not associated with the user;
receiving from the user via the interface an indication of at least one magazine, an indication of an issue of the at least one magazine, and an indication of at least one advertiser, wherein the indication of the at least one magazine received from the user comprises a selection by the user of at least one of the displayed indications of the multiple magazines; and,
in response to the received indications, displaying via the interface digital images of magazine advertisements associated with the at least one advertiser published in the issue of the at least one magazine.

22. The method of claim 21, wherein the indication of the at least one magazine received from the user corresponds to all magazines for which digital images of magazine advertisements are available to be presented.

23. The method of claim 21, wherein the indication of the at least one magazine received from the user corresponds to at least one magazine of a competitor of the user.

24. The method of claim 23, wherein the displayed indications of the multiple magazines correspond to magazines included in a competitive set associated with the user.

25. The method of claim 21, wherein the indication of the at least one advertiser received from the user corresponds to all advertisers published in the issue of the at least one magazine.

26. The method of claim 21, wherein the receiving from the user via the interface the indication of the at least one magazine, the indication of the issue of the at least one magazine, and the indication of the at least one advertiser comprises:
displaying via the interface indications of multiple magazines for which digital images of magazine advertisements are available;
receiving from the user via the interface a selection of at least one of the displayed indications of the multiple magazines;
in response to the received selection of at least one of the displayed indications of the multiple magazines, displaying via the interface indications of multiple issues associated with the received selection for which digital images of magazine advertisements are available;
receiving from the user via the interface a selection of one of the displayed indications of the multiple issues;
in response to the received selection of one of the displayed indications of the multiple issues, displaying via the interface indications of multiple advertisers associated with the received selection for which digital images of magazine advertisements are available; and,
receiving from the user via the interface a selection of one of the displayed indications of the multiple advertisers.

27. The method of claim 26, wherein the displayed indications of the multiple advertisers include indications of the number of pages of magazine advertisements published by each of the multiple advertisers in the issue of the at least one magazine.

28. The method of claim 21, wherein the digital images of magazine advertisements are displayed in an order in which the magazine advertisements were published in the issue of the at least one magazine.

29. The method of claim 21, further comprising:
receiving from the user via the interface a selection of one of the displayed digital images of magazine advertisements; and
displaying via the interface indications of one or more of the displayed digital images of magazine advertisements that are associated with the same magazine advertisement as the received selection.

30. The method of claim 21, wherein the digital images of magazine advertisements are displayable in different sizes, and wherein the method further comprises receiving from the user via the interface a selection of a size in which to display the digital images of magazine advertisements.

31. The method of claim 21, wherein the method further comprises displaying indications of new issues for which digital images of magazine advertisements are available.

32. The method of claim 21, wherein the method further comprises:
receiving from the user via the interface a selection of one of the displayed digital images of magazine advertisements;
in response to the received selection of one of the displayed digital images of magazine advertisements, displaying via the interface indications of one or more advertisers associated with the received selection;
receiving from the user via the interface a selection of one of the displayed indications of the one or more advertisers; and,
in response to the received selection of one of the displayed indications of the one or more advertisers, adding the selected advertisers to a favorites list associated with the user.
